(19) United States
(12) Patent Application Publication
(10) Pub. No.: US 2022/0148047 A1
(43) Pub. Date: May 12, 2022

(54) SYSTEMS AND METHODS FOR FACILITATING AN IMPROVED IN-STORE EXPERIENCE

(71) Applicant: The Gap, Inc., Albuquerque, NM (US)

(72) Inventors: Shivkumar Krishnan, Los Altos, CA (US); Amir Islam, San Ramon, CA (US)

(21) Appl. No.: 17/525,586

(22) Filed: Nov. 12, 2021

Related U.S. Application Data
(60) Provisional application No. 63/113,111, filed on Nov. 12, 2020.

(51) Int. Cl. G06Q 30/02; G06Q 30/06

(52) U.S. Cl. CPC G06Q 30/0281; G06Q 30/0637; G06Q 30/0625; G06Q 30/0639

(57) ABSTRACT

Systems and methods for facilitating an improved in-store experience are provided. A server stores a virtual queue. A selection of a first product in a plurality of products is received. The selection is based on an evaluation of an image, which places the first product in a bin of one or more products. A first request to purchase the one or more products is received including an inspection requirement. A second request for placement in a virtual queue is communicated including a first corresponding location identifier associated with a physical address of the one or more products, a corresponding stock unit identifier for each product in the one or more products, and a transaction identifier. The corresponding client identifier is assigned in a record of indexed positions. The inspection is facilitated. An authorization of the first request to purchase the one or more products is provided.

### CROSS-REFERENCE TO RELATED APPLICATION

The present application claims priority to U.S. Provisional Patent Application No. 63/113,111, entitled “Systems and Methods for Facilitating an Improved In-Store Experience,” filed Nov. 12, 2020, which is hereby incorporated by reference in its entirety.

### TECHNICAL FIELD

The present disclosure generally relates to systems and methods for facilitating an improved in-store experience. More particularly, the present disclosure relates to systems and methods designed to facilitate a virtual queue purchase authorization taking place at a client device.

### BACKGROUND

Enterprise computer systems often include a server associated with a physical location, such as a brick-and-mortar retail location. The server facilitates transactions associated with the purchase of a product at a point-of-sales device, which is operated by a sales associate at the retail location. Accordingly, a consumer at the retail location is reliant on the sales associate to purchase the product. Conventionally, the consumer waits in a physical queue with the product until an available sales associate can facilitate the transaction for the user. Not only does this provide an inconvenience to the consumer by wasting time standing in the physical queue, but also opportunities are lost when this time could have otherwise been afforded to enjoying other aspects of the retail location, such as further browsing of products offered at the retail location. Additionally, when a consumer has selected a product to purchase, the consumer may have an inquiry related to the product or a desire to learn about other related products. However, conventional in-store experiences require the consumer to locate a sales associate within the retail store to relay the inquiry, which can lead to a dissatisfactory experience for the consumer when, for example, a sales associate is not readily available. Moreover, other than observing the number of customers already standing in line to purchase products, the consumer has little to no knowledge regarding how long it will take to purchase a product at a physical retail location. For instance, the consumer does not know how fast the physical queue will move (e.g., how long they will be in the physical queue to purchase the product), and whether or not additional sales associates are available to help with purchases. Moreover, in stores that have multiple registers for purchasing products in various locations throughout the store, the customer is not aware of whether other locations in the store may have a shorter physical queue. Furthermore, in stores that have fitting rooms, the customer cannot always locate a sales associate to facilitate access to a fitting room, yet alone an available fitting room, for the customer to try on various garments. Moreover, in conventional stores, the customer is often responsible for locating and bringing various garments from in-store displays to the available fitting room. These drawbacks can dissuade a consumer from purchasing a product at the physical location, particularly in periods of high customer demand such as the Holiday season (between Thanksgiving and New Year's day in the United States).

Conventional solutions to these problems provide a dedicated point-of-sales device that allows a consumer to purchase a product without the sales associate. However, these dedicated point-of-sales device solutions still require the consumer to wait in a physical queue if more than one consumer wishes to use the point-of-sales device. Moreover, the ability of such devices to further engage the consumer with the physical location is unsatisfactory. For instance, they fail to provide promotional materials. Also, if the consumer has an inquiry related to the product or a desire to learn about other related products at the point-of-sales device, the consumer is still tasked with waiting for a sales associate to provide an answer to the inquiry, such as finding an available fitting room or exchanging items when trying on different fits of garments. Furthermore, the dedicated point-of-sales device solutions place an undue burden on the consumer to facilitate their purchase in a time-efficient manner if other consumers are waiting in a queue for access to the device.

Other conventional solutions provide ways for consumers to curate a shopping list and facilitate requests to try on items using the shopping list. However, such conventional solutions place an undue burden on sales associates, such as by requiring the sales associates to not only manage the retrieval and delivery of the items to the customer, but also manually respond to and assist with each request. As such, an inherent limited capacity of the sales associates to traverse locations between the consumers and various items whilst balancing the processing and handling of such requests against restrictions at each store (e.g., fitting room capacity) is burdensome on the sales associates. In turn, this burden for the sales associate deteriorates the in-store experience for the consumers.

Given the above background, there is a need in the art for improved systems and methods for facilitating in-store shopping experience.

The information disclosed in this background section is only for enhancement of understanding of the general background of the invention and should not be taken as an acknowledgement or any form of suggestion that this information forms the prior art already known to a person skilled in the art.

### SUMMARY

Advantageously, the systems and methods detailed in the present disclosure address the shortcomings in the prior art detailed above.

Systems and methods for facilitating an improved in-store experience are provided. Specifically, the present disclosure facilitates an improved in-store experience by an enterprise service that, for purchasing products, such as by providing a virtual queue at a server.

In some embodiments, the server stores a virtual queue that includes a corresponding location identifier associated with a physical address, such as a brick-and-mortar retail location, and a record of a plurality of indexed positions. Each respective indexed position includes a corresponding client identifier, providing a one-to-one relationship between a respective indexed position and a client identifier. Each respective client identifier is associated with at least one corresponding client device in a plurality of client devices. This allows a user associated with the at least one corresponding client device to access and receive information associated with the virtual queue from each client device in the at least one corresponding client device. In some embodiments, the virtual queue is utilized to facilitate various purchase and/or inspection services (e.g., fittings) associated with a respective product.

In some embodiments, each indexed position within the virtual queue includes a position identifier, which links the respective indexed position with a position in the virtual queue. In some embodiments, this allows for sub-categorization of the virtual queue based on one or more subject type identifiers.

In some embodiments, at the server, an update for the virtual queue is received. The update includes modification of the record of the plurality of indexed positions to indicate a change in at least one position identifier. This updates the record of the indexed positions. One example of such updating removes the corresponding client identifier from the virtual queue. The update of the record of indexed positions is communicated to a first client device. This enables a user at the first client device to receive the update to the virtual queue. Accordingly, the virtual queue allows the user to facilitate various services associated with engaging the physical address without requiring assistance from a subject (e.g., sales associate) associated with the physical address, such as signaling a first request for information about a product, a second request to purchase the product without standing in a physical queue, a third request to inspect the product when the product is not currently displayed in store, and the like. Additionally, the device (e.g., first client device) allows for the authorization of the purchase of one or more products.

In some embodiments, the device includes a display, an objective lens, and a two-dimensional pixelated detector in communication with the objective lens. In some embodiments, a selection of a first product in a plurality of products is received at the device. The selection of the first product is based on an evaluation of an image captured by the two-dimensional pixelated detector, such as a first image of a code associated with the first product and/or a second image of a surface of the first product. From this, the first product is placed in a bin of one or more products associated with a corresponding client identifier in a plurality of client identifiers, which indicates an interest of a user associated with the corresponding client identifier in purchasing the first product.

As some point, a first request to purchase each product in the one or more products of the bin is received. In some embodiments, the first request includes a requirement for an inspection of a first product in the one or more products, such as a quality inspection by a sales associate and/or a fitting inspection by a consumer. In response to the first request, a second request for placement in the virtual queue (e.g., to ultimately purchase the one more products) is communicated to a server (e.g., the server storing the virtual queue). The second request includes a corresponding location identifier associated with a physical address of the one or more products, which signals a desire for the consumer to inspect and/or purchase a respective product (e.g., the first product) in the one or more products of the bin at the physical address associated with the corresponding location identifier. The request further includes a corresponding stock unit identifier for each product in the one or more products and a transaction identifier of the request to purchase each product in the one or more products, which provides an accounting of the request to purchase the one or more products of bin and a proper inventory of the one or more products at the physical location. From this, in response to communicating the request to purchase the one or more products of the bin, an authorization of the request to purchase each product in the one or more products is received, allowing for the approval to purchase and/or actual purchase of the first product. Accordingly, in some embodiments, the consumer receives information associated with a product, receives authorization to purchase the product, receives an inspection fitting of the product, or a combination thereof without interacting with an associate at the physical address or, in some embodiments, being physically present at the physical address.

Turning to more specific aspects of the present disclosure, in some embodiments, the present disclosure is directed to providing a computer implemented method. The method is implemented at a device. The device includes a display, an objective lens, and a two-dimensional pixelated detector in communication with the objective lens. The device further includes one or more processors, and memory storing one or more programs for execution by the one or more processors. The one or more programs includes instructions for receiving, in electronic form, a selection of a first product in a plurality of products. The selection of the first product is based, at least in part, on an evaluation of an image captured by the two-dimensional pixelated detector. From this, the first product is placed in a bin of one or more products associated with a corresponding client identifier in a plurality of client identifiers. The one or more programs includes instructions for receiving, in electronic form, a first request to purchase each product in the one or more products of the bin. The first request includes a requirement for an inspection, by a subject, of the first product in the one or more products. The one or more programs includes instructions for communicating, to a server, in response to receiving the first request, a second request for placement in a virtual queue in a memory of the server. The second request includes a first corresponding location identifier associated with a physical address of the one or more products. Moreover, the second request includes a corresponding stock unit identifier for each product in the one or more products. Furthermore, the second request includes a transaction identifier of the request to purchase each product in the one or more products. From this, the corresponding client identifier is associated with a respective indexed position in record of a plurality of indexed positions of the virtual queue. The one or more programs includes instructions for facilitating, in accordance with a determination that the respective indexed position satisfies each threshold condition in a plurality of threshold conditions, the inspection of the first product. Furthermore, the one or more programs includes instructions for receiving, in response to the facilitating the inspection, an authorization of the first request to purchase each product in the one or more products. Accordingly, the purchase of the first product at the device is authorized.

In some embodiments, the selection of the first product is provided by a user through an input mechanism of the device.

In some embodiments, the receiving the selection of the first product further includes displaying, on the display, in response to the selection of the first product, a corresponding plurality of catalog information associated with the first product.

In some embodiments, the receiving the selection of the first product further includes displaying, on the display, in response to the selection of the first product, a second product associated with the first product.

In some embodiments, the association of the second product with the first product is determined by an administrator associated with the server.

In some embodiments, the association of the second product with the first product is determined by one or more computational models based, at least in part, on a respective user preference for the second product.

In some embodiments, the respective user preference for the second product includes a garment type, a monetary value, an expected profit, or a combination thereof.

In some embodiments, the user of the device is unassociated with the device.

In some embodiments, the transaction identifier of the communicating the second request includes financial information associated with the user of the device.

In some embodiments, the authorization of the first request further includes initiating a purchase request, receiving payment, authorizing the payment, charging a payment amount, charging a credit account, completing a sale transaction, a capacity of a physical address, a spatial dimension associated with a set of products in the one or more products of the bin, or a combination thereof.

In some embodiments, the user of the device is provided with a confirmation of the authorization prior to the purchase of each product in the one or more products.

In some embodiments, the authorization of the first request is associated with the corresponding location identifier associated with the physical address of the one or more products.

In some embodiments, the record of the plurality of indexed positions further includes, for each corresponding client device in the at least one corresponding client devices, a corresponding location identifier associated with the corresponding client device.

In some embodiments, the plurality of threshold conditions includes verification of the identity of the user, a frequency of requests made by the user, time of day, or a combination thereof.

In some embodiments, the image depicts all or a portion of the first product.

In some embodiments, the facilitation of the inspection is performed by the user.

In some embodiments, each respective position in the plurality of indexed positions further includes a respective subject type identifier in a plurality (e.g., enumerated list) of subject type identifiers.

In some embodiments, the plurality of subject identifiers includes an inquiry type identifier, a purchase order type identifier, a return order type identifier, or a combination thereof.

In accordance with an aspect of the present disclosure, the above and other objects can be accomplished by the provision of a virtual queue and/or purchase authorization service, which provides mechanisms to improve in-store experiences for users.

Another aspect of the present disclosure is directed to providing a computer system. The computer system includes a display, an objective lens, and a two-dimensional pixelated detector in communication with the objective lens. The computer system further includes one or more processors, and memory storing one or more programs for execution by the one or more processors. The one or more programs includes instructions for receiving, in electronic form, a selection of a first product in a plurality of products. The selection of the first product is based, at least in part, on evaluation of an image captured by the detector. From this, the first product is placed in a bin of one or more products associated with a corresponding client identifier in a plurality of client identifiers. The one or more programs includes instructions for receiving at some point in time, in electronic form, a first request to purchase each product in the one or more products of the bin. The first request includes an indication of a requirement for inspection, by a subject, of the first product in the one or more products. The one or more programs includes instructions for communicating, to a server, in response to the receiving the first request, a second request for placement in a virtual queue in the server memory. The second request includes a first corresponding location identifier associated with a physical address of the one or more products. Moreover, the second request includes a corresponding stock unit identifier for each product in the one or more products. Furthermore, the second request includes a transaction identifier of the request to purchase each product in the one or more products. From this, the corresponding client identifier is associated with a respective indexed position in record of a plurality of indexed positions of the virtual queue. The one or more programs includes instructions for facilitating, in accordance with a determination that the respective indexed position satisfies each threshold condition in a plurality of threshold conditions, inspection of the first product. Furthermore, the one or more programs includes instructions for receiving, in response to the facilitating the inspection, authorization of the first request to purchase each product in the one or more products. Accordingly, the purchase of the one or more product (e.g., the first product) at the device is authorized.

Yet another aspect of the present disclosure is directed to providing a non-transitory computer readable storage medium. The non-transitory computer readable storage medium includes program code instructions stored thereon that, when executed by a processor, cause the processor to perform a method. The method includes receiving, in electronic form, selection of a first product in a plurality of products. The selection of the first product is based, at least in part, on evaluation of an image captured by a two-dimensional pixelated detector associated with the processor. From this, the first product is placed in a bin of one or more products associated with a corresponding client identifier in a plurality of client identifiers. The method includes receiving, in electronic form, a first request to purchase each product in the one or more products of the bin. The first request includes an indication of a requirement for inspection, by a subject, of the first product. The method includes communicating, to a server, in response to the receiving the first request, a second request for placement in a virtual queue in server memory. The second request includes a first corresponding location identifier associated with a physical address of the one or more products. Moreover, the second request includes a corresponding stock unit identifier for each product in the one or more products. Furthermore, the second request includes a transaction identifier of the request to purchase each product in the one or more products. From this, the corresponding client identifier is associated with a respective indexed position in record of a plurality of indexed positions of the virtual queue. The method includes facilitating, in accordance with a determination that the respective indexed position satisfies each threshold condition in a plurality of threshold conditions, the inspection of the first product. Furthermore, the method includes receiving, in response to facilitation of the inspection, an authorization of the first request to purchase each product in the one or more products. Accordingly, the purchase of the one or more products (e.g., the first product) at the device is authorized.

The systems, methods, and apparatuses of the present disclosure have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates an exemplary system topology including an enterprise server system, in accordance with an exemplary embodiment of the present disclosure;

FIGS. 2A and 2B collectively illustrate various modules and/or components of an enterprise server system, in accordance with an exemplary embodiment of the present disclosure;

FIG. 3 illustrates various modules and/or components of a client device, in accordance with an exemplary embodiment of the present disclosure;

FIG. 4 provides a flow chart of processes and features of a computer system for facilitating a virtual queue, in accordance with an exemplary embodiment of the present disclosure;

FIG. 5 illustrates a user interface of a client device, in accordance with an exemplary embodiment of the present disclosure;

FIG. 6 illustrates an initial user interface of a client application executed on a client device, in accordance with an exemplary embodiment of the present disclosure;

FIG. 7 illustrates a user interface for displaying information associated with a virtual queue, in accordance with an exemplary embodiment of the present disclosure; and

FIG. 8 illustrates a user interface for selecting a first product, in accordance with an exemplary embodiment of the present disclosure;

FIG. 9 illustrates another user interface for selecting a first product, in accordance with an embodiment of the present disclosure;

FIG. 10 illustrates yet another user interface for selecting a first product, in accordance with an embodiment of the present disclosure;

FIG. 11 illustrates yet another user interface for selecting a first product, in accordance with an embodiment of the present disclosure;

FIG. 12 illustrates a user interface for displaying a second product associated with a first product, in accordance with an embodiment of the present disclosure;

FIG. 13 illustrates a user interface for providing a first request that includes a requirement for an inspection, in accordance with an embodiment of the present disclosure;

FIG. 14 illustrates another user interface for providing a first request that includes a requirement for an inspection, in accordance with an embodiment of the present disclosure;

FIG. 15 illustrates a user interface for receiving an authorization of a first request to purchase one or more products, in accordance with an embodiment of the present disclosure;

FIG. 16 illustrates another user interface for receiving an authorization of a first request to purchase one or more products, in accordance with an embodiment of the present disclosure;

FIG. 17 illustrates yet another user interface for receiving an authorization of a first request to purchase one or more products, in accordance with an embodiment of the present disclosure; and

FIGS. 18 and 19 collectively illustrate yet another user interface for receiving an authorization of a first request to purchase one or more products, in accordance with an embodiment of the present disclosure.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Enterprises struggle to maintain a balance between bringing a maximum number of consumers into a retail location and attending to each of the consumer's needs. If the retail location becomes overwhelmed with consumers or understaffed with sales associates to reach a bandwidth limit of the retail location, consumers can have a negative in-store experience due to a lack of attention and a need to interact with a sales associate. For instance, if a consumer needs to quickly purchase a specific product, the consumer can be dissuaded from the purchase if a physical queue to purchase has a long wait time or if the user cannot locate the specific product. As another non-limiting example, if the consumer needs to try one or more products, the consumer can be dissuaded from the purchase if the consumer cannot locate an available fitting room, cannot locate a particular stock unit identifier (e.g., a stock keeping unit (SKU)) of the product, wants to try on numerous products, and the like. Moreover, if the consumer has an inquiry related to the specific product, finding a sales associate to answer the inquiry can prove to be difficult.

To address this, the systems and methods of the present disclosure provide enterprise software services, particularly services that facilitate a virtual queue and/or authorization for purchase of one or more products. A virtual queue service allows a consumer to request entry into, or removal from, the virtual queue for a specific location, and/or a user (e.g., the consumer or a sales associate) to receive an update associated with the virtual queue, such as a change in position in the virtual queue. Thus, the user can tend to the virtual queue depending on a record of indexed positions of the virtual queue or, in some embodiments, based on a subject type identifier associated with an indexed position of the virtual queue. This provides an improved in-store experience for the consumer by minimizing time waiting for the sales associate, while also enabling the consumer to be independent of sales associates.

Furthermore, the authorization for the product purchase service provided by the present disclosure allows the user to purchase the one or more products, or at least communicate a request to purchase the one or more products and receive authorization to purchase the one or more products, without interacting with the sales associate. In some embodiments, the request to purchase the one or more products includes a requirement for an inspection of a first product in the one or more products. In some embodiments, the inspection of the first product includes providing a fitting room for the customer. The fitting room includes an area where the customer is allowed to inspect (e.g., try on) a respective product before deciding to make a purchase of the respective product. From this, the present disclosure allows a consumer to interact with a retail location, such as pre-purchase products at the retail location or receive information related to the products at the retail location, without having to engage the sales associate. This improves the consumer in-store experience by allowing the consumer to dictate when and/how the consumer interacts with the retail location without burdening or inconveniencing the user with physical queues and unnecessary human contact.

Reference will now be made in detail to various embodiments of the present disclosure, examples of which are illustrated in the accompanying drawing and described below. While the disclosure will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents, and other embodiments, which may be included within the spirit and scope of the present invention as defined by the appended claims.

It will also be understood that, although the terms first, second, etc. may be used herein to describe various elements, these elements should not be limited by these terms. These terms are only used to distinguish one element from another. For example, a first client device could be termed a second client device, and, similarly, a second client device could be termed a first client device, without departing from the scope of the present disclosure. The first client device and the second client device are both client devices, but they are not the same client device.

The terminology used in the present disclosure is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and or “comprising,” when used in this specification, specify the presence of stated features, integers, steps, operations, elements, and or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Furthermore, when a reference number is given an “i^{th}” denotation, the reference number refers to a generic component, set, or embodiment. For instance, a client device termed “client device i” refers to the i^{th} client device in a plurality of client devices (e.g., a client device 300-i in a plurality of client devices 300).

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions below are not intended to be exhaustive or to limit the implementations to the precise forms disclosed. Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case- and business-related constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

As used herein, the term “dynamically” means an ability to update a program while the program is currently running.

Additionally, the terms “client,” “subject,” “end-user,” “user”, “customer” and “consumer” are used interchangeably herein unless expressly stated otherwise.

Furthermore, the term “lens,” as used herein, includes a single lens or an assembly of lenses, unless expressly stated otherwise.

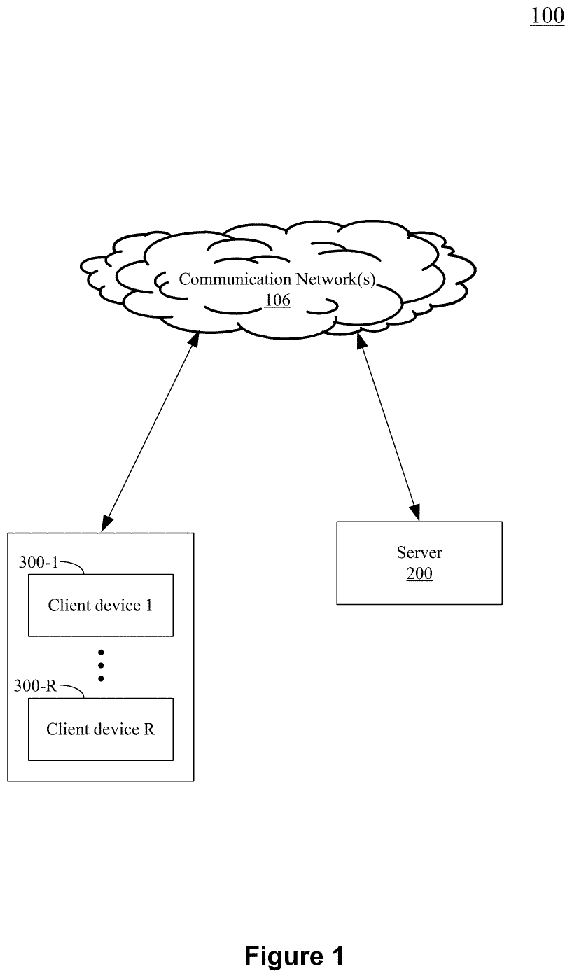

In the present disclosure, unless expressly stated otherwise, descriptions of devices and systems will include implementations of one or more computers. For instance, and for purposes of illustration in FIG. 1, a client device 300 is represented as single device that includes all the functionality of the client device 300. However, the present disclosure is not limited thereto. For instance, the functionality of the client device 300 may be spread across any number of networked computers and/or reside on each of several networked computers and/or be hosted on one or more virtual machines and/or containers at a remote location accessible across a communications network (e.g., communications network 106). One of skill in the art will appreciate that a wide array of different computer topologies is possible for the client device 300, and other devices and systems of the preset disclosure, and that all such topologies are within the scope of the present disclosure.

An aspect of the present disclosure is directed to providing an enterprise software service, particularly for the facilitation of virtual queues and/or an authorization of a purchase of one or more products by a customer.

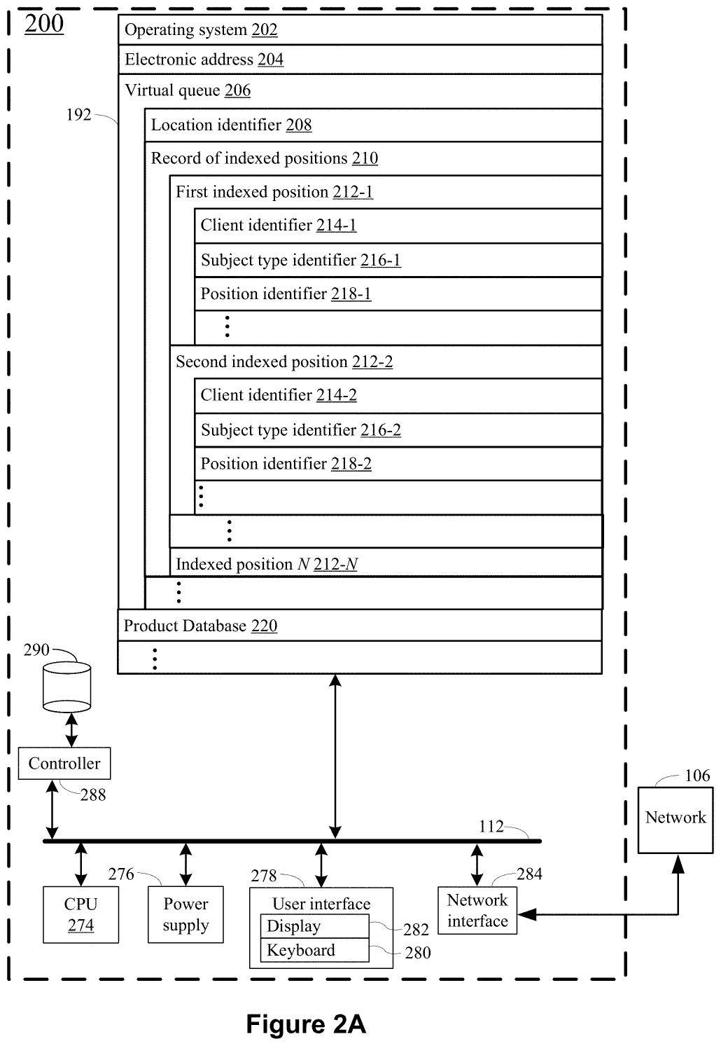

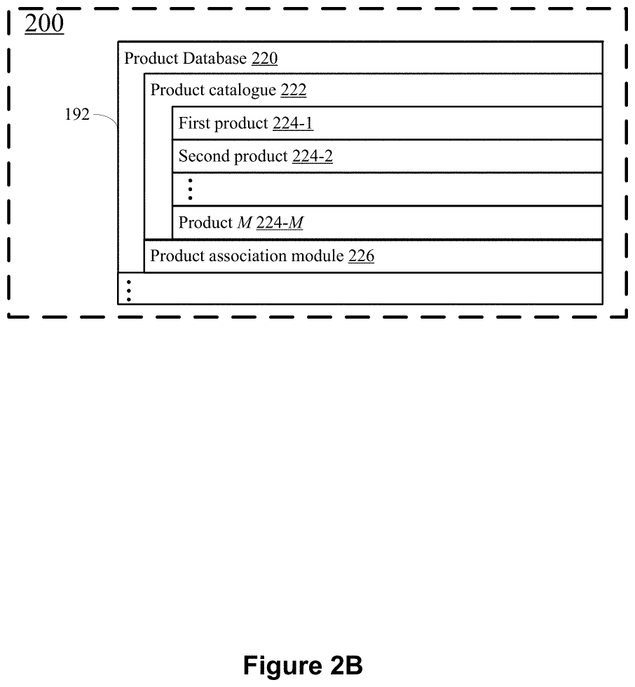

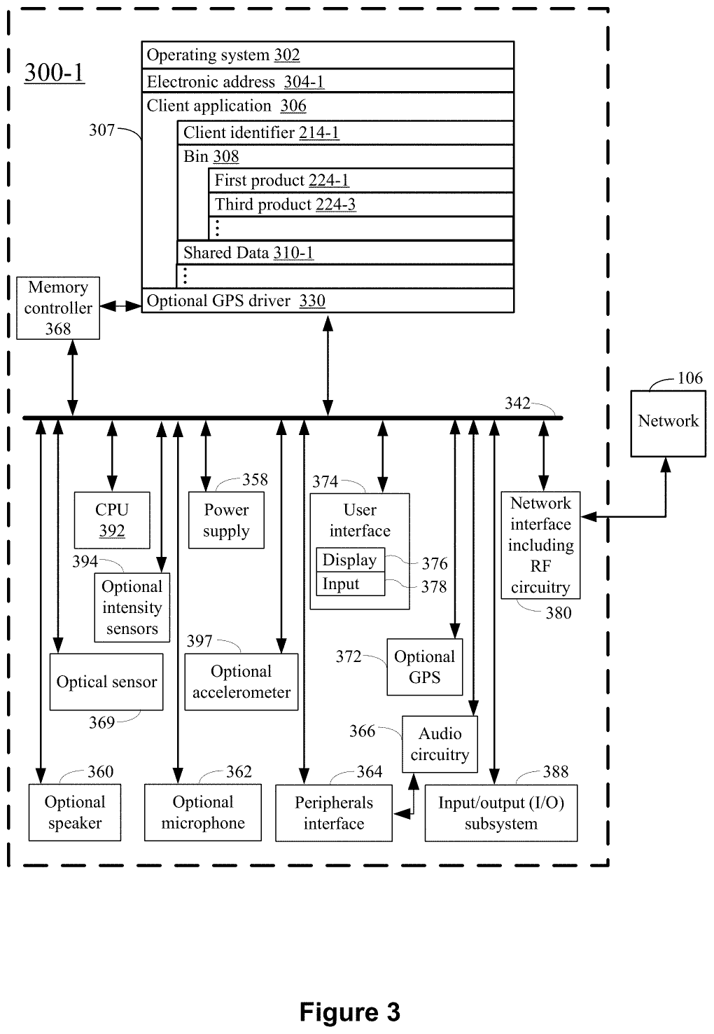

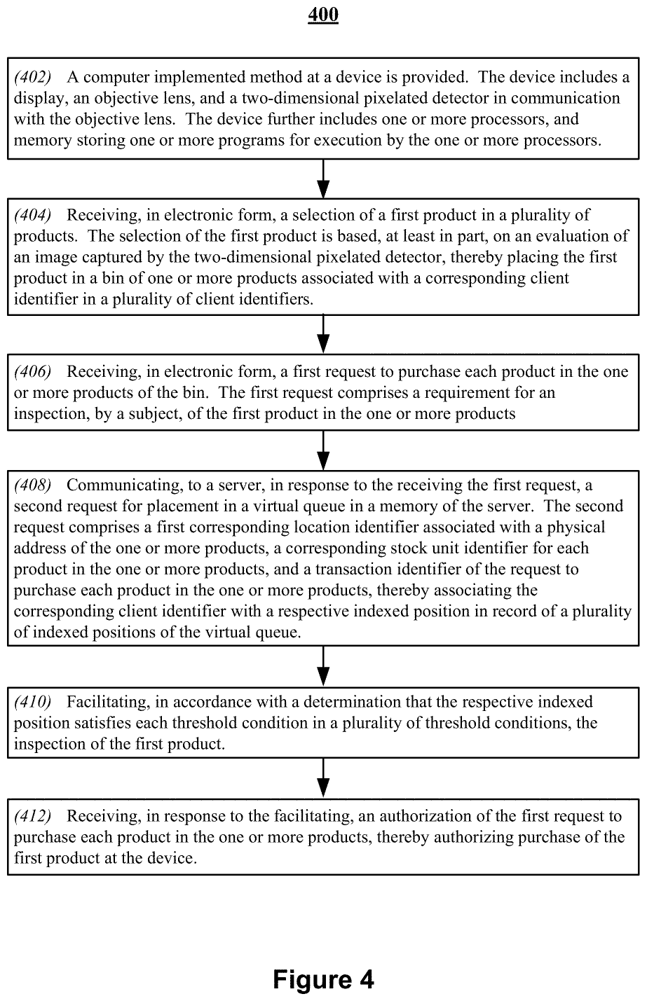

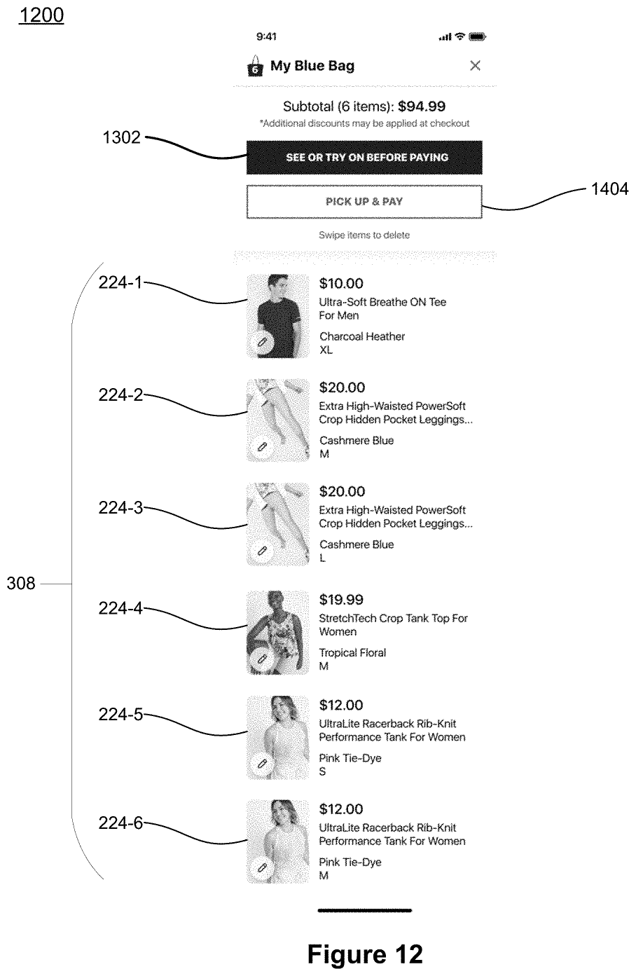

In some embodiments, a computer implemented method (e.g., method 400 of FIG. 4) operating at a device (e.g., client device 300 of FIGS. 1, 3, and 5) is provided. The device 300 includes a display (e.g., display 376 of FIG. 3), an objective lens, and a two-dimensional pixelated detector in communication with the objective lens (e.g., optical sensor 369 of FIG. 3). The device 300 further includes one or more processors (e.g., processor 392 of FIG. 3), and memory (e.g., memory 307 of FIG. 3) storing one or more programs (e.g., client application 306 of FIG. 3) for execution by the one or more processors 392. The computer implemented method includes receiving, in electronic form, a selection of a first product in a plurality of products (e.g., plurality of products 224 of FIG. 2B). The selection of the first product is based, at least in part, on an evaluation of an image captured by the two-dimensional pixelated detector. From this, the first product is placed in a bin (e.g., bin 308 of FIG. 12) of one or more products associated with a corresponding client identifier in a plurality of client identifiers. The computer implemented method further includes receiving, in electronic form, a first request to purchase each product in the one or more products of the bin. The first request includes a requirement for an inspection, by a subject, of the first product in the one or more products. The computer implemented method includes communicating, to a server, in response to receiving the first request, a second request for placement in a virtual queue in a memory of the server. The second request includes a first corresponding location identifier associated with a physical address of the one or more products. Moreover, the second request includes a corresponding stock unit identifier for each product in the one or more products. Furthermore, the second request includes a transaction identifier of the request to purchase each product in the one or more products. From this, the corresponding client identifier is associated with a respective indexed position in record of a plurality of indexed positions of the virtual queue. The computer implemented method includes facilitating, in accordance with a determination that the respective indexed position satisfies each threshold condition in a plurality of threshold conditions, the inspection of the first product. Furthermore, the method includes receiving, in response to facilitating the inspection, an authorization of the first request to purchase each product in the one or more products. In this way, the purchase of the first product at the device is authorized.

FIG. 1 illustrates an exemplary topography of an integrated system 100 for providing a virtual queue and/or an authorization of a purchase service. The integrated system 100 includes a server 200 that stores a virtual queue (e.g., virtual queue 206 of FIG. 2A), and a product database (e.g., product database 220 of FIG. 2A). One or more client devices (e.g., client device 300-1 of FIGS. 1, 3, and 5) communicate with the server 200 through a communications network 106, such as communicating a request for an update of the virtual queue 206. Each client device 300 is associated with at least one user (e.g., a first client device 300-1 is associated with a first user, a second client device 300-2 is associated with a second user, a third client device 300-3 associated with a third user and a fourth user, etc.).

A detailed description of a system 100 for providing a virtual queue and/or an authorization of a purchase service in accordance with the present disclosure is described in conjunction with FIG. 1 through FIG. 3. As such, FIG. 1 through FIG. 3 collectively illustrate an exemplary topology of the system 100 in accordance with the present disclosure. In the topology, there is a server 200 for facilitating the virtual queue 206 and/or the product database 220, and communicating data elements related to the virtual queue 206 and/or the product database 220 to one or more client devices 300, such as a request for an indexed position (e.g., first indexed position 212-1 of FIG. 2A) in the virtual queue 206, an update to the virtual queue, a request for purchase of a respective product, and the like.

Referring to FIG. 1, the server 200 is configured to store a virtual queue 206 and/or a product database 220. In some embodiments, the server 200 receives an update to the virtual queue 206, an update to the product database 220, a request associated with either the virtual queue 206 or the product database 220, or a combination thereof. As a non-limiting example, in some embodiments, the server receives a selection of a respective product in a plurality of products for placement in a bin (e.g., block 404 of FIG. 4). The updates to the virtual queue 206 and/or data elements associated with the product database 220 (e.g., data elements providing information associated with first product 224-1 of FIG. 2B), are provided in electronic form to a respective client device 300.

In some embodiments, the server 200 receives the data elements wirelessly through radio-frequency (RF) signals. In some embodiments, such signals are in accordance with an 802.11 (Wi-Fi), Bluetooth, or ZigBee standard.

In some embodiments, the server 200 is not proximate to the user or a client device 300 and/or does not have wireless capabilities or such wireless capabilities are not used for the purpose of facilitating the virtual queue 206, such as acquiring an update of the virtual queue 206 or a request for placement in the virtual queue (e.g., block 408 of FIG. 4). In such embodiments, a communication network 106 is utilized to communicate an update for the virtual queue 206 from a source (e.g., a remote client device 300) to the server 200.

Examples of communication networks 106 include, but are not limited to, the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of the present disclosure.

Of course, other topologies of the system 100 other than the one depicted in FIG. 1 are possible. For instance, in some embodiments, rather than relying on a communications network 106, the server 200 wirelessly transmits information directly to the client devices 300. Further, in some embodiments, the server 200 constitutes a portable electronic device, a server computer, or in fact constitute several computers that are linked together in a network, or are instantiated as one or virtual machines and/or containers in a cloud-computing context. As such, the exemplary topology shown in FIG. 1 merely serves to describe the features of an embodiment of the present disclosure in a manner that will be readily understood to one of skill in the art.

Turning to FIGS. 2A and 2B with the foregoing in mind, in some embodiments, the server 200 includes one or more computers. For purposes of illustration in FIGS. 2A and 2B, server 200 is represented as a single computer that includes all of the functionality for providing a virtual queue 206 and/or purchase authorization for a product 224 system. However, the present disclosure is not limited thereto. In some embodiments, the functionality for providing a server 200 is spread across any number of networked computers, and/or resides on each of several networked computers, and/or is hosted on one or more virtual machines and/or one or more containers at a remote location accessible across the communications network 106. One of skill in the art will appreciate that any of a wide array of different computer topologies are used for the application and all such topologies are within the scope of the present disclosure.

An exemplary server 200 for providing a virtual queue 206 and/or an authorization of a purchase for a product 224 is provided. The server 200 includes one or more processing units (CPU's) 274, a network or other communications interface 284, a memory 192 (e.g., random access memory), one or more magnetic disk storage and or persistent devices 290 optionally accessed by one or more controllers 288, one or more communication busses 112 for interconnecting the aforementioned components, a user interface 278, the user interface 278 including a display 282 and input 280 (e.g., keyboard, keypad, touch screen), and a power supply 276 for powering the aforementioned components. In some embodiments, data elements in memory 192 are seamlessly shared with non-volatile memory 290 using known computing techniques such as caching. In some embodiments, the memory 192 and/or memory 290 includes mass storage that is remotely located with respect to the central processing unit(s) 274. In other words, some data stored in the memory 192 and/or memory 290 may in fact be hosted on computers that are external to the server 200 but that can be electronically accessed by the server 200 over an Internet, intranet, or other form of network or electronic cable (illustrated as element 106 in FIG. 2A) using network interface 284.

In some embodiments, the memory 192 of the server 200 for providing a virtual queue and/or an authorization of a purchase includes:
instructions, programs, data, or information associated with an operating system 202 (e.g., iOS, ANDROID, DARWIN, RTXC, LINUX, OS X, WINDOWS, or an embedded operating system such as VxWorks), which includes various software components and/or drivers for controlling and managing general system tasks (e.g., memory management, storage device control, power management, etc.) and facilitates communication between various hardware and software components;
an electronic address 204 associated with the server 200;
a virtual queue 206 that includes a corresponding location identifier 208 associated with a physical location of the virtual queue 206, a record of indexed positions 210 having one or more indexed positions 212, each respective indexed position 212 including a respective client identifier 214, and, optionally, a subject type identifier 216 associated with the respective indexed position 212 and/or a position identifier 218; and
a product database 220 storing a product catalog 222 of one or more products 224 and associated information related to the product, and, optionally, further storing a product association module 226 for evaluating the one or more products 224 and providing and/or retaining associations between various products 224 using one or more computational models.

The virtual queue 206 includes the corresponding location identifier 208 that is configured to associate the virtual queue 207 with a physical location, such as a brick-and-mortal retail store, a point-of-sales (POS) device associated with the store, and the like. As a non-limiting example, in some embodiments, the virtual queue 206 is configured for a checkout line at the store, for placing one or more purchase orders, requesting assistance at the store, and the like. For instance, in some embodiments, when a user is near to completing a selection of a first product 224-1 (e.g., block 404 of FIG. 4), the user indicates that they would like to be placed in the virtual queue 206 to inspect the first product 224-1. Accordingly, the server 200 assigns the user a respective position within the virtual queue 206 using a corresponding client identifier associated with the user. In some embodiments, the virtual queue 206 of the present disclosure cannot be mentally performed.

In this way, the virtual queue 206 of the server 200 facilitates indexing one or more requests associated with a client device 300. As described supra, the virtual queue 206 includes the corresponding location identifier 208 that associates the virtual queue 206 with the physical address. In this way, the virtual queue 206 provides an indexed listing that is particular to the physical address. In some embodiments, the physical address associated with the location identifier 208 provides a relation with a particular physical address associated with an entity. By way of example, consider a business entity having three locations with a first location identifier 208-1 associated with a first location of the business entity, a second location identifier 208-2 associated with a second location of the business entity, and a third location identifier 208-3 associated with a third location of the business entity. In this way, in some embodiments, a virtual queue 206 is hosted at the server 200 and provided for each physical address associated with the business entity and linked through the corresponding location identifier 208 associated with a respective location of the business entity. However, the present disclosure is not limited thereto.

The record of indexed positions 210 provides a listing of a plurality of indexed positions 212. The plurality indexed positions 212 includes an initial indexed position in the plurality of indexed positions 212 (e.g., first position 212-1) and a final indexed position in the plurality of indexed positions 212 (indexed position N 212-N). In some embodiments, the initial indexed position 212 and the final indexed position 212 are the same indexed position 212, such that the plurality of indexed positions 212 contains the one indexed position 212. However, the present disclosure is not limited thereto. In this way, the record of indexed positions 210 provides a hierarchy of indexed positions 212, which can be communicated to one or more client devices 300. In some embodiments, a respective position within the virtual queue 206 is determined (e.g., using one or more computational models) by an order in which a user requests placement in the virtual queue 206 (e.g., on the basis of when a user requests placement in the virtual queue 206 relative to when others requested placement in the virtual queue 206). In some embodiments, the respective position within the virtual queue 206 is determined based on the number of products selected by the user (e.g., the number of products in the bin associated with the corresponding client identifier of the user), a relative monetary/goodwill value of the customer and/or the bin to the store (e.g., a first user that is a frequent shopper and customer who purchases high profit margin products is given a better, or higher position in the virtual queue 206 in comparison to a second user that is an infrequent shopper or a frequent returner of products), a projected probability that the store will audit the customer, whether the user is elderly or handicapped, or a combination thereof. In some embodiments, the plurality of indexed positions includes at least 3 indexed positions, at least 5 indexed positions, at least 25 indexed positions, at least 50 indexed positions, at least 125 indexed positions, at least 400 indexed positions, at least 1,000 indexed positions, at least 2,500 indexed positions, at least 5,000 indexed positions, or a combination thereof.

The product database 220 retains a product catalog 222 of a plurality of products 224 (e.g., first product 224-1, second product 224-2, . . . , product M 224-M). In some embodiments, the plurality of products in the product catalog includes at least 20 products, at least 50 products, at least 100 products, at least 250 products, at least 500 products, at least 800 products, at least 1,000 products, at least 1,500 products, at least 4,000 products, at least 7,000 products, at least 10,000 products, at least 50,000 products, or a combination thereof.

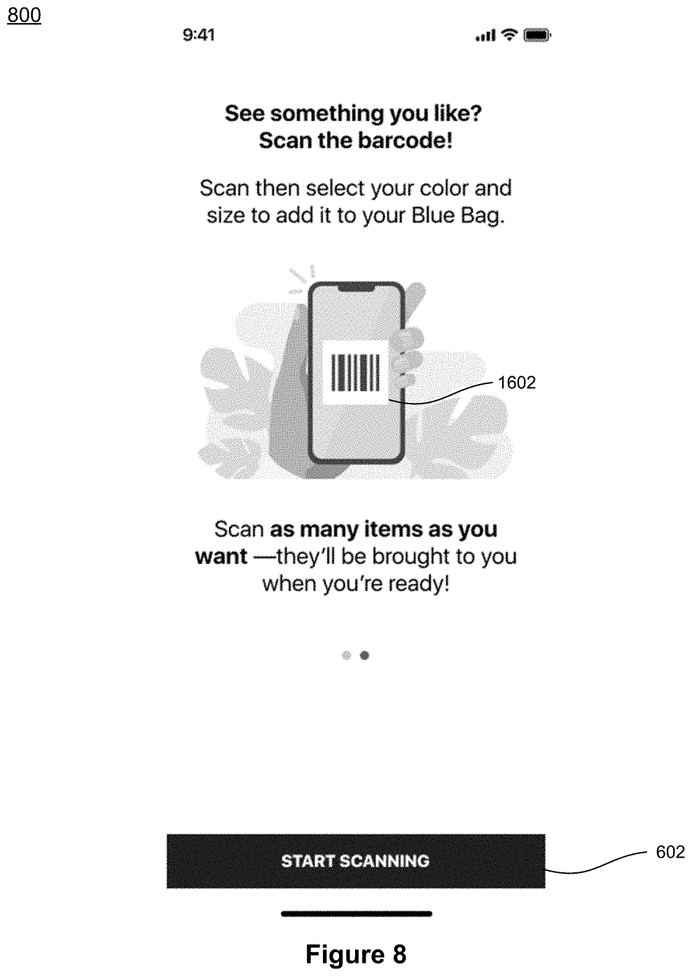

In some embodiments, the product catalog 222 is unique to the corresponding location identifier associated the server 200. For instance, in some embodiments, the product catalog 222 provides a listing of each respective product 224 available for purchase at the physical location associated with the corresponding location identifier. By way of example, in some such embodiments, the product catalog 222 provides a listing of each respective product that was previously available for purchase at the physical location within a first period of time (e.g., a first listing of one or more products that is sold out at the physical location), each respective product that is currently available for purchase at the physical location, each respective product that will be available for purchase at the physical location within a second period of time (e.g., a second listing of one or more products that will be available during a future season at the physical location), or a combination thereof. However, the present disclosure is not limited thereto. By providing the listing of each respective product 224 available for purchase at the physical location, the server 200 can facilitate the virtual queue 206 to assist a user that needs to try on (e.g., block 410 of FIG. 4) a respective product 224, compare two or more products 224, purchase the respective product 224 quickly, or have the respective product 224 shipped to a physical location the user plans to be in at a later date and time. Each respective product 224 includes a corresponding plurality of catalog information (e.g., catalog information 800-1 of FIG. 8) associated with the respective product 224.

Furthermore, this plurality of catalog information describes one or more attributes associated with the respective product 224. In some embodiments, the one or more attributes described by the plurality of catalog information 800 includes a price of the respective product 224, one or more SKUs of the respective product (e.g., one or more color variations of the respective product 224, one or more size variations of the respective product, one or more pattern variations of the respective product 224, etc.), one or more locations associated with the respective product 224 (e.g., a physical store address location that has the respective product 224, a physical location of the respective product 224 within the store, etc.), a corresponding stock unit identifier of the respective product 224, and the like. In this way, a user can access the various catalog information associated with the respective product 224 through the product database 220.

Additionally, in some embodiments, the product database 220 includes the product association module 226 that facilitates storing and generating one or more associations formed between various products 224, such as by using one or more computational models. For instance, in some embodiments, one or more predetermined associations with various products are provide by an administrator of the server 200 and stored at the product association module 226, such as a promotional campaign that associates a first product 224-1 with a second product 224-2 in order to promote sales of the first product 224-1 and the second product 224-2. In some embodiments, the product association module 226 generates an association between one or more products 224 using one or more computational models based on a user setting, such as a preference for an association for a first type of product 224 (e.g., a preference for Male clothing products 224), allowing personalized recommendations for products 224 to be provided based on the user setting. Furthermore, in some embodiments, the user setting includes a user selection of a respective product 224, such as a selection to 224 to place the respective product 224 in a bin (e.g., bin 308 of FIG. 3, selection 800-2 of FIG. 8, etc.). In some embodiments, the product association module 226 generates an association between one or more products 224 based on an evaluation of a history of the user, such as a purchase history of the user. However, the present disclosure is not limited thereto. For instance, in some embodiments, the respective user preference for the second product 224-2 is based on a size of the first product 224-1, a mass and/or volume of the first product 224-1, a fragileness of the first product 224-1, a first physical location of the first product 224-1, the first physical location of the first product 224-1 relative to a second physical location (e.g., associated with the second product 224-2, a POS device, an exit, etc.), a number of instances of the first product 224-1 within a store or department, an individual or aggregate fulfillment confidence scores for the first product 224-1, or a combination thereof. In some embodiments, the second product 224-2 is associated with the first product 224-1 based on an expected retrieval time or distance traveled (e.g., least squares, traveling salesman, distance, weight carried, etc.) and the like. However, the present disclosure is not limited thereto.

In some embodiments, one or more of the above identified data stores and/or modules of the server 200 are stored in one or more of the previously described memory devices (e.g., memory 192 and/or memory 290), and correspond to a set of instructions for performing a function described above. The above-identified data, modules, or programs (e.g., sets of instructions) need not be implemented as separate software programs, procedures, or modules. Thus, various subsets of these modules may be combined or otherwise re-arranged in various implementations. In some implementations, the memory 192 and/or memory 290 optionally stores a subset of the modules and data structures identified above. Furthermore, in some embodiments the memory 192 and/or memory 290 stores additional modules and data structures not described above.

Referring to FIG. 3, a description of an exemplary client device 300 that can be used with the presently disclosure is provided. In some embodiments, a client device 300 includes a smart phone (e.g., an iPhone, an Android device, etc.), a laptop computer, a tablet computer, a desktop computer, a wearable device (e.g., a smart watch, a heads-up display (HUD) device, etc.), a television (e.g., a smart television), or another form of electronic device such as a gaming console, and the like. However, the present disclosure is not limited thereto. For instance, in some embodiments, the client device is a stand-alone device associated with a retail store, such as a kiosk POS device, or a portion of the kiosk POS device that is used for presenting product information, advertising, customer assistance (e.g., a map associated with a physical location), or a combination thereof. Accordingly, the client device 300 is a suitable device for the purpose of allowing a user of the client device 300 to interact with a virtual queue 206, such as by selecting a first product 224-1 for inspection.

The client device 300 illustrated in FIG. 3 has one or more processing units (CPU's) 392, peripherals interface 364, memory controller 368, a network or other communications interface 380, a memory 307 (e.g., random access memory), a user interface 374, the user interface 374 including a display 376 and input 378 (e.g., keyboard, keypad, touch screen, etc.), an optional accelerometer 397, an optional GPS 372, optional audio circuitry 366, an optional speaker 360, an optional microphone 362, one or more optional intensity sensors 394, an optional input/output (I/O) subsystem 388, one or more optional optical sensors 368, one or more communication busses 342 for interconnecting the aforementioned components, and a power supply 358 for powering the aforementioned components.

In some embodiments, the input 378 is a touch-sensitive display, such as a touch-sensitive surface. In some embodiments, the user interface 374 includes one or more soft keyboard embodiments. In some embodiments, the soft keyboard embodiments include standard (QWERTY) and or non-standard configurations of symbols on the displayed icons. The input 378 and/or the user interface 374 is utilized by an end-user of the respective client device 300 (e.g., a respective subject) to input various commands (e.g., a push command) to the respective client device.

The client device 300 illustrated in FIG. 3 optionally includes, in addition to accelerometer(s) 397, a magnetometer, and a global positioning system (GPS) 372 (or GLONASS or other global navigation system) receiver for obtaining information concerning a current location (e.g., a latitude, a longitude, an elevation, etc.) and/or an orientation (e.g., a portrait or a landscape orientation of the device) of the client device 300.

It should be appreciated that the client device 300 illustrated in FIG. 3 is only one example of a multifunction device that may be used for an authorization of a purchase of a product 224 and/or communicate a request association with a virtual queue 206. Thus, the client device 300 optionally has more or fewer components than shown, optionally combines two or more components, or optionally has a different configuration or arrangement of the components. The various components shown in FIG. 3 are implemented in hardware, software, firmware, or a combination thereof, including one or more signal processing and/or application specific integrated circuits.

Memory 307 of the client device 300 illustrated in FIG. 3 optionally includes high-speed random access memory and optionally also includes non-volatile memory, such as one or more magnetic disk storage devices, flash memory devices, or other non-volatile solid-state memory devices. Access to memory 307 by other components of the client device 300, such as CPU(s) 392 is, optionally, controlled by the memory controller.

In some embodiments, the peripherals interface 364 couple input and output peripherals of the device to the CPU(s) 392 and the memory 307. The one or more CPU(s) 392 run or execute various software programs and/or sets of instructions stored in the memory 307, such as the application store 306, to perform various functions for the client device 300 and process data.

In some embodiments, the peripherals interface 364, the CPU(s) 392, and the memory controller are implemented on a single chip. In some other embodiments, the peripherals interface 364, the CPU(s) 392, and the memory controller are implemented on separate chips.

RF (radio frequency) circuitry of network interface receives and sends RF signals, also called electromagnetic signals. In some embodiments, the data constructs are received using the present RF circuitry from one or more devices such as client device 300 associated with a subject. In some embodiments, the RF circuitry 380 converts electrical signals to from electromagnetic signals and communicates with communications networks (e.g., communication network 106 of FIG. 1) and other communications devices, client devices 300, and/or the server 200 via the electromagnetic signals. The RF circuitry 380 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 380 optionally communicates with the communication network 106. In some embodiments, the circuitry 380 does not include RF circuitry and, in fact, is connected to the communication network 106 through one or more hard wires (e.g., an optical cable, a coaxial cable, or the like).

In some embodiments, the audio circuitry 366, the optional speaker 360, and the optional microphone 362 provide an audio interface between the user and the client device 300, enabling the client device 300 to provide communications including audio data provided through the audio circuitry 366, the optional speaker 360, and/or the optional microphone 362. The audio circuitry 366 receives audio data from the peripherals interface 364, converts the audio data to electrical signals, and transmits the electrical signals to the speaker 360. The speaker 360 converts the electrical signals to human-audible sound waves. The audio circuitry 366 also receives electrical signals converted by the microphone 362 from sound waves. The audio circuitry 366 converts the electrical signal to audio data and transmits the audio data to peripherals interface 364 for processing. Audio data is, optionally, retrieved from and or transmitted to the memory 307 and or the RF circuitry 380 by the peripherals interface 364.

In some embodiments, the power supply 358 optionally includes a power management system, one or more power sources (e.g., one or more batteries, alternating current (AC)), a recharging system, a power failure detection circuit, a power converter or inverter, a power status indicator (e.g., a light-emitting diode (LED)) and any other components associated with the generation, management, and distribution of power in portable devices.

In some embodiments, the client device 300 optionally also includes one or more optical sensors 368. The optical sensor(s) 368 optionally include charge-coupled device (CCD) or complementary metal-oxide semiconductor (CMOS) phototransistors. The optical sensor(s) 368 receive light from the environment, projected through one or more objective lens of the client device 300, and converts the light to data representing an image using a two-dimensional pixelated detector in communication with the one or more objective lens. The optical sensor(s) 368 optionally capture still images and or video, such as an image of a first product 224-1 selected by the user. In some embodiments, an optical sensor is disposed on a back end portion of the client device 300 (e.g., opposite the display 376 on a front end portion of the client device 300) so that the input 378 is enabled for use as a viewfinder for still and or video image acquisition. In some embodiments, another optical sensor 368 is located on the front end portion of the client device 300 so that an image of the user is obtained (e.g., to capture a user profile image). However, the present disclosure is not limited thereto.

In some embodiments, the memory 307 of the client device 300 stores:
an operating system 302 that includes procedures for handling various basic system services;
an electronic address 304 associated with the client device 300;
a client application 306 for facilitating access to a virtual queue and/or a product catalog, and for storing a client identifier 214 associated with the client device 300, and a bin 308 storing one or more products 224 selected via the client device 300; and
a shared data 310 that allows for data elements to be communicated and utilized by one or more client devices 300 having access to the shared data 310.

As illustrated in FIG. 3, a client device 300 preferably includes an operating system 302 that includes procedures for handling various basic system services. The operating system 302 (e.g., iOS, ANDROID, DARWIN, RTXC, LINUX, UNIX, OS X, WINDOWS, or an embedded operating system such as VxWorks) includes various software components and or drivers for controlling and managing general system tasks (e.g., memory management, storage device control, power management, etc.) and facilitates communication between various hardware and software components.

An electronic address 304 is associated with each client device 300, which is utilized to at least uniquely identify the client device 300 from other devices and components of the integrated system 100. In some embodiments, the client device 300 includes a serial number, and optionally, a model number or manufacturer information that further identifies the device 300. In some embodiments, the electronic address 304 associated with the client device 300 is used to provide a source of a data received from and/or provided to the client device 300.

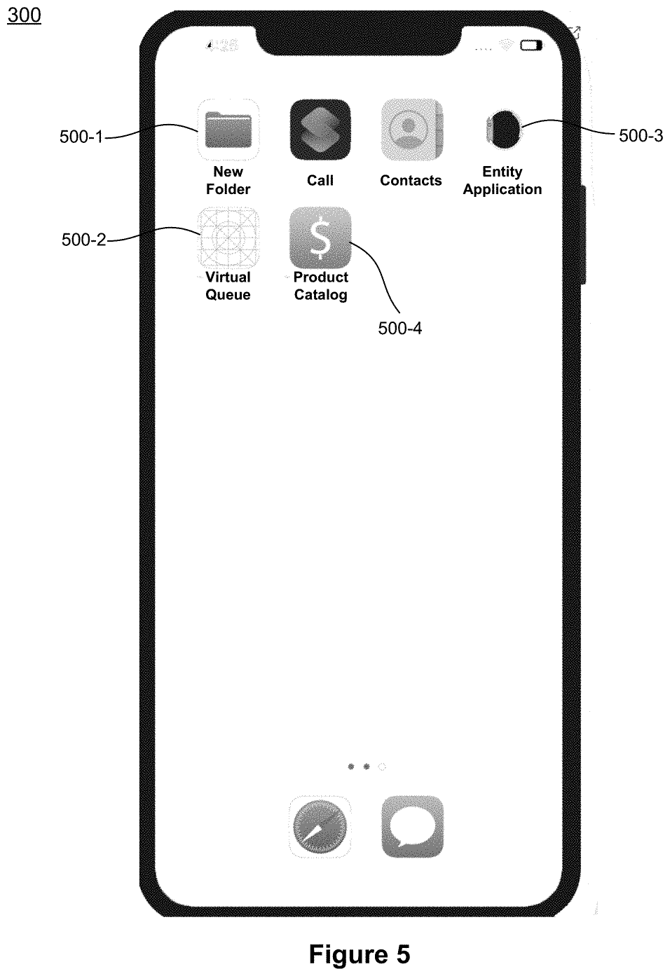

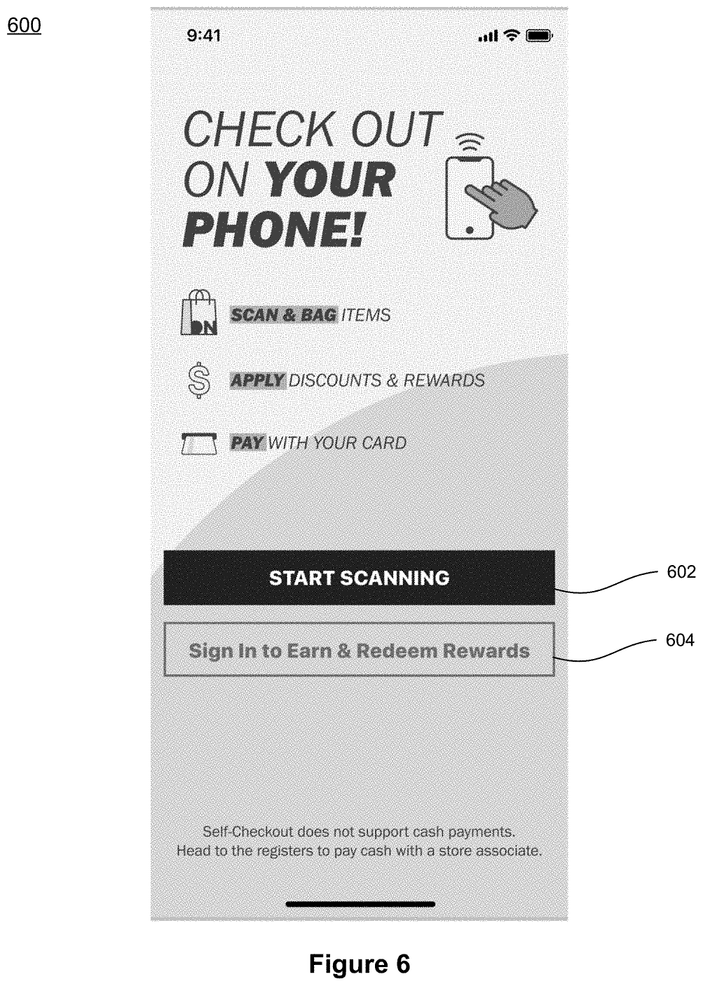

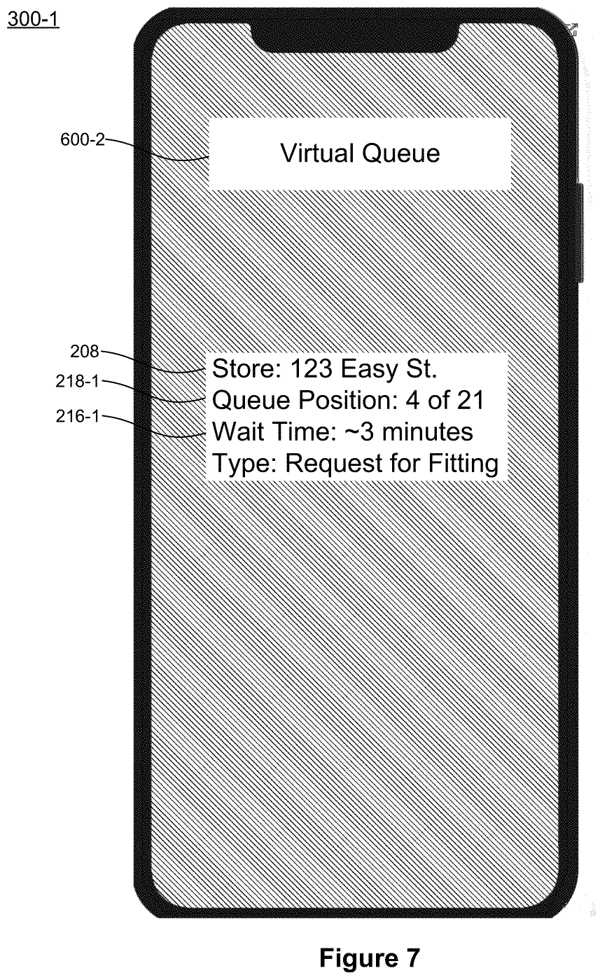

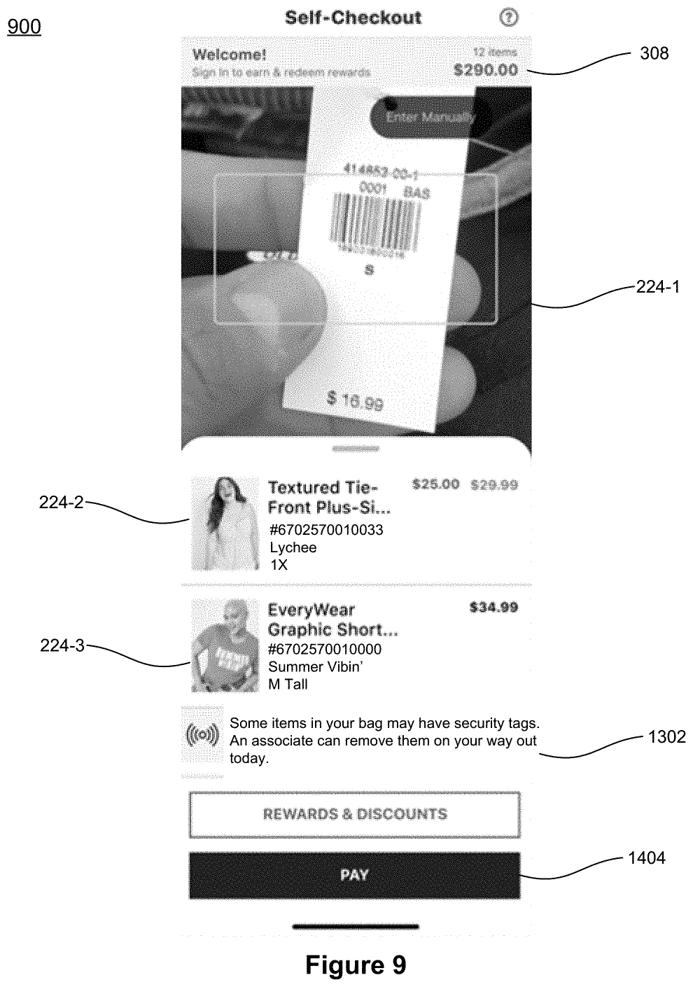

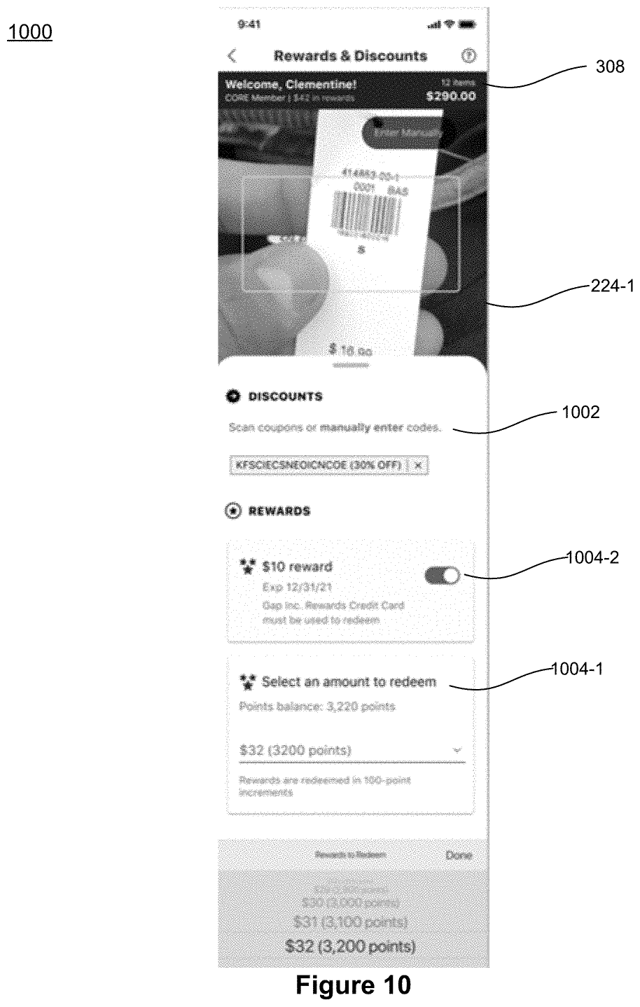

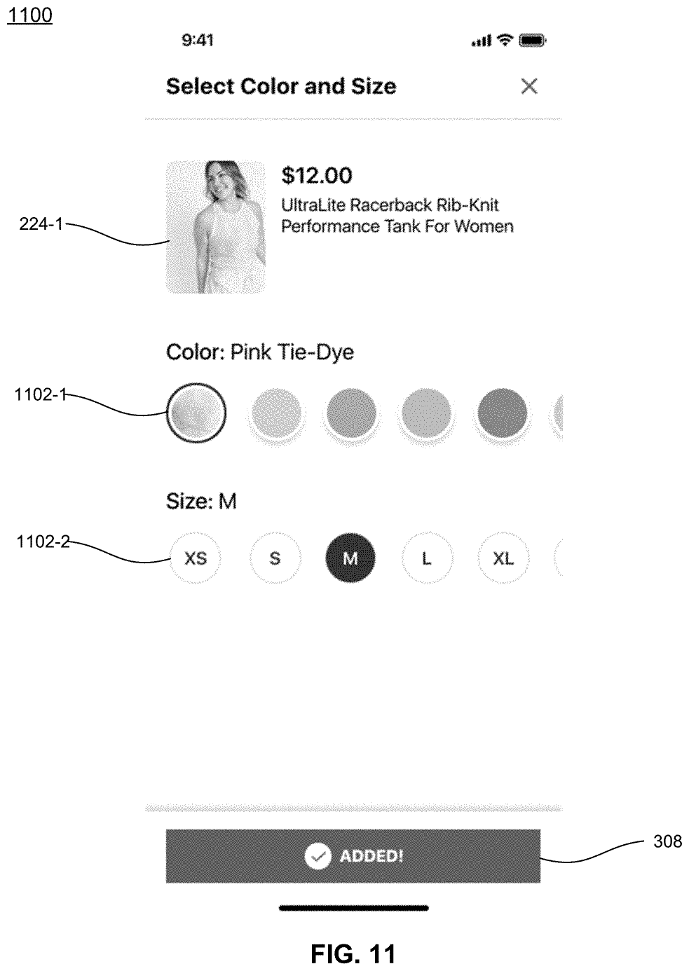

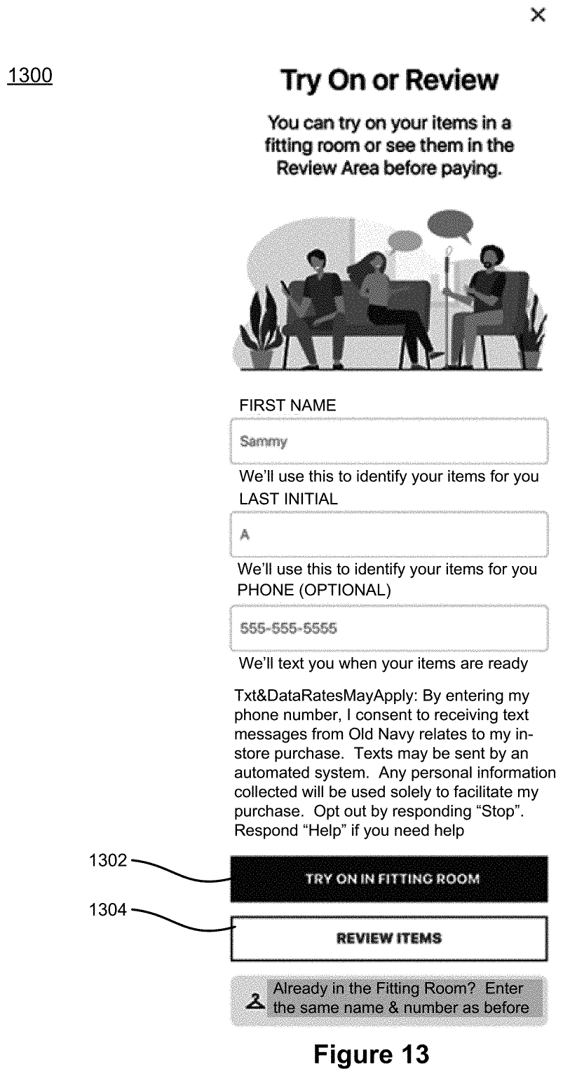

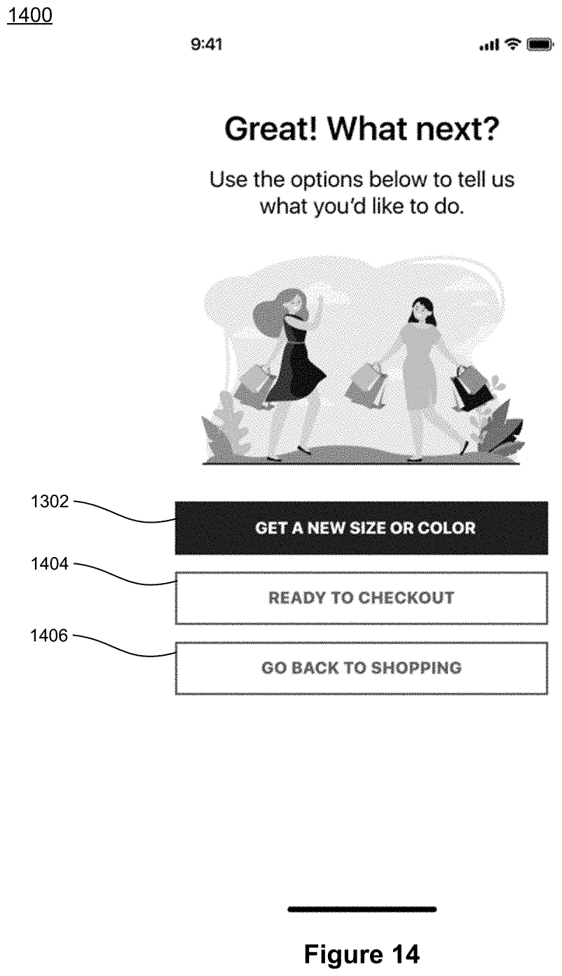

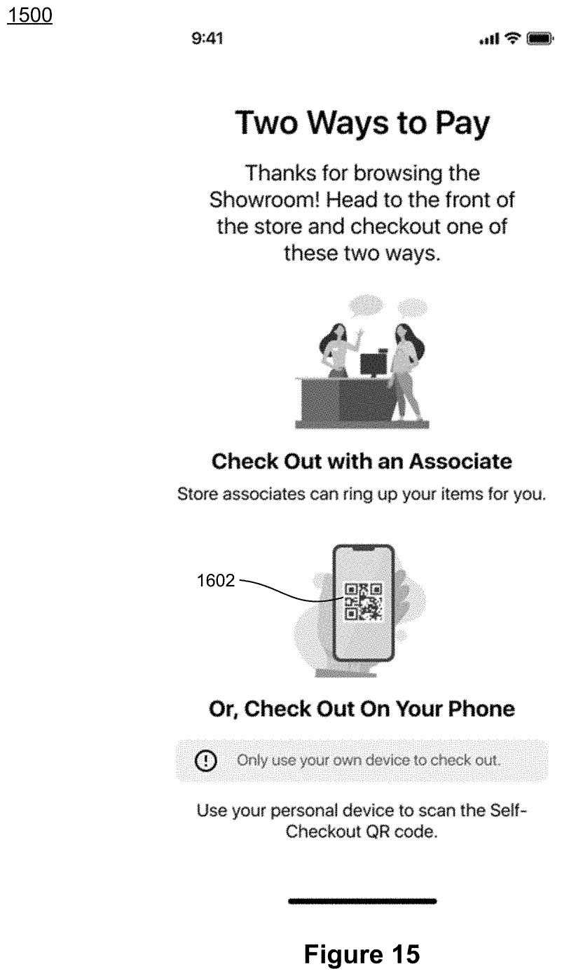

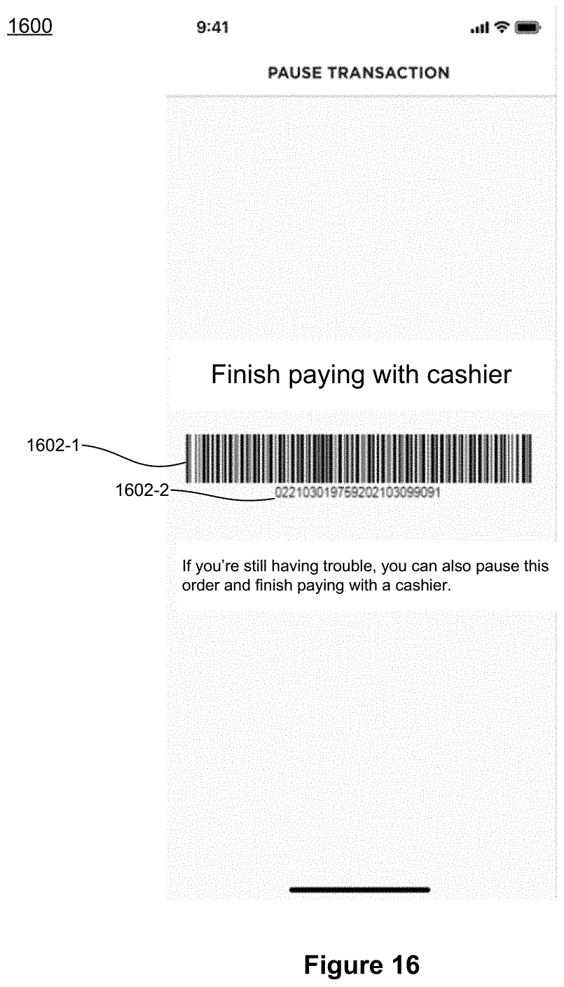

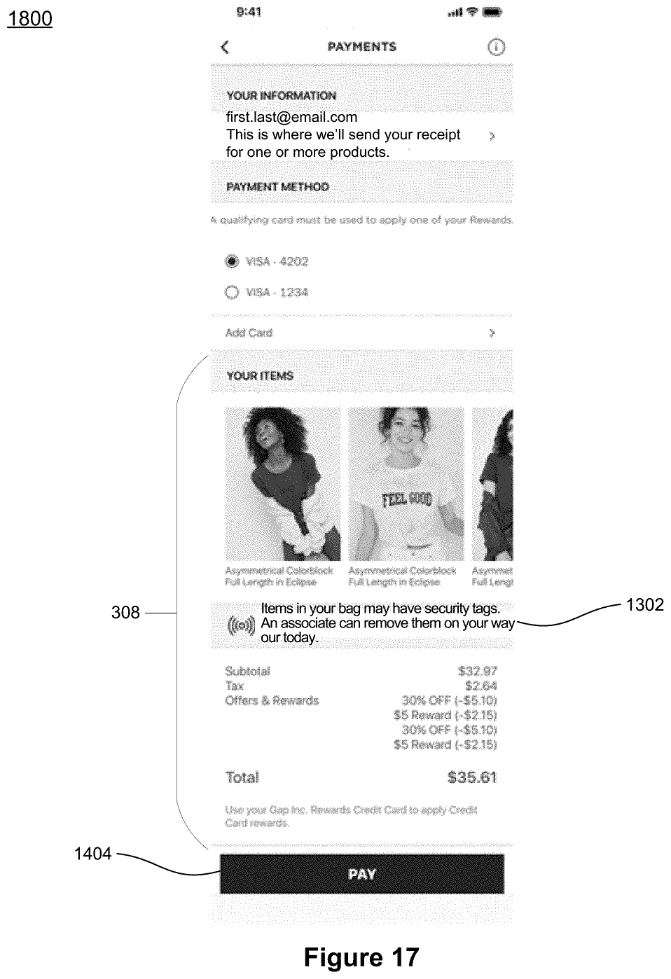

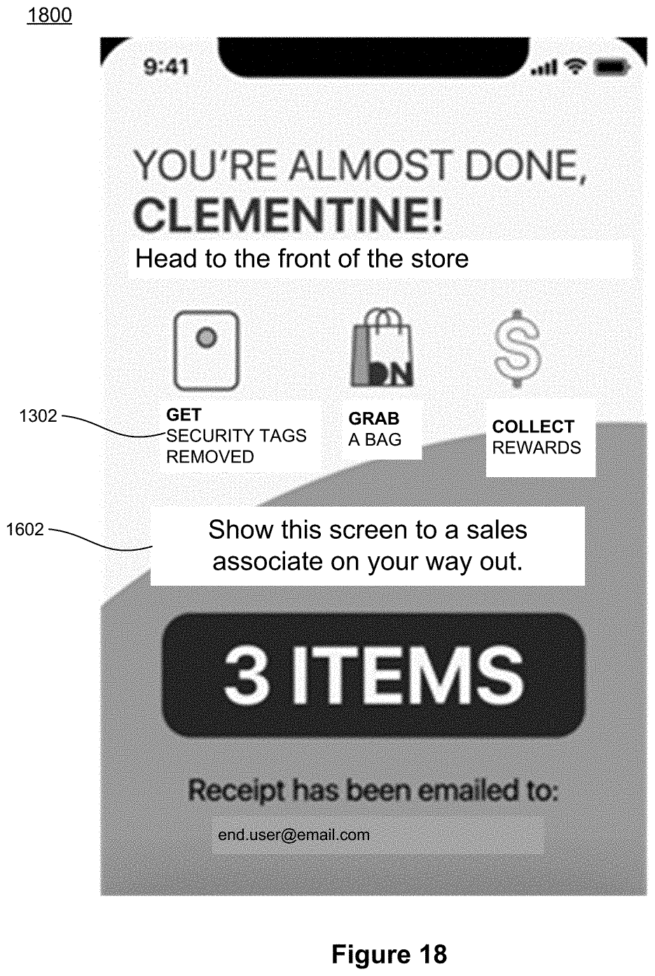

In some embodiments, the client application 306 provides access to a virtual queue (e.g., virtual queue 206 of FIG. 2A) and/or allows for a user to request an authorization for purchase of a first product 224-1 service (e.g., user interface 500 of FIG. 5, user interface 600 of FIG. 6, user interface 700 of FIG. 7, user interface 800 of FIG. 8, user interface 900 of FIG. 9, user interface 1000 of FIG. 10, user interface 1100 of FIG. 11, user interface 1200 of FIG. 12, user interface 1300 of FIG. 13, user interface 1400 of FIG. 14, user interface 1500 of FIG. 15, user interface 1600 of FIG. 16, user interface 1700 of FIG. 17, user interface 1800 of FIG. 18, etc.). The client application 306 includes a client identifier 214, which links a user of the client device 300 with the client application 306. In some embodiments, the client identifier is provided by logging into the client application 306 at the client device 300, such that more than one user can access the client application 306 using the client device 300. However, the present disclosure is not limited thereto. In some embodiments, the client identifier 214 is transiently stored in the memory 307 of the client device 300, such that a user provides a corresponding client identifier 214 at each session of utilizing the client application 306. Accordingly, by linking the user of the client device to the client application by way of the client identifier 214, in some embodiments, the user utilizes a first client device 300-1 to complete a first task (e.g., add a first product 224-1 to a bin 308 associated with the corresponding client identifier of the user) and further utilize a second client device 300-2 to complete a second task (e.g., purchase the first product 224-1 in the bin associated with the corresponding client identifier). However, the present disclosure is not limited thereto.

In some embodiments, the client application 306 includes a bin 308 that facilitates retaining one or more selections of products 224 provided by through the client device 300, such as a selection of a first product 224-1 and a third product 224-3. In some embodiments, the bin 308 is configured to retain at least 1 product, at least 5 products, at least 10 products, at least 20 products, at least 50 products, at least 100 products, at least 1,000 products, or a combination thereof. Accordingly, in some embodiments, the bin 308 includes multiple products 224 for purchase by the user. For instance, in some embodiments, the bin 308 includes information about a respective product 224 of the bin 308, such as a corresponding location identifier of the respective product 224, a corresponding stock unit identifier of the respective product 224, a transaction identifier for requesting purchase of the respective product 224, a price of the respective product 224, or a combination thereof. As such, in some such embodiments, the bin 308 is configured as an electronic shopping bin that is associated with the user and, optionally, displayed at least in part, on the display 376 of the client device 300. Accordingly, in some embodiments, before or after inspection of a respective product in the bin 308 (e.g., block 410 of FIG. 4), each respective product 224 in the bin 308 is then realized in the form of a physical shopping bin, such as a cart or a bag, that accommodates each respective product 224. As such, in some embodiments, the systems and methods of the present disclosure allow and end-user of the client device 300 to place one or more products 224 in a digital bin 308 and then proceed to either inspect a set of products 224 (e.g., some or all) in the one or more products 224 and/or purchase the one or more products 224 of the bin 224, which allows for realizing the digital bin 308 in the form of a physical shopping bin that accommodates the physical versions one or more products 224 (e.g., block 404 of FIG. 4, block 406 of FIG. 4, block 410 of FIG. 4, block 412 of FIG. 4, or a combination thereof) from the digital versions of the one or more products 224 of the bin 308. However, the present disclosure in not limited thereto. In some embodiments, the allowing of the end-user of the client device 300 to place one or more products 224 in a digital bin 308 and then proceed to either inspect a set of products 224 (e.g., some or all) in the one or more products 224 and/or purchase the one or more products 224 of the bin 224 is facilitated by using a virtual queue 206 of the server 200.

In some embodiments, the client application 306 is utilized to present a visualization of the virtual queue 206, such as through a user interface of the client application 306. In some embodiments, the visualization includes a listing of one or more corresponding client identifiers in a plurality of client identifiers of the virtual queue 206, one or more corresponding location identifier associated with a physical address of the one or more products 224 of a bin 308 associated with a respective client identifier in the plurality of client identifiers, a transaction identifier of the request to purchase a respective product of the virtual queue 206, a record of a plurality of indexed positions, a corresponding location identifier associated with the corresponding client device. or a combination thereof. In some embodiments, the client application 306 is configured to present a first user interface when the end-user is a consumer (e.g., to present only the respective indexed position associated with the corresponding client identifier further associated with the end-user) or present a second user interface when the end-user is a sales associate (e.g., to present the plurality of indexed positions, a set of indexed positions such as an inquiry type identifier, a purchase order type identifier, a return order type identifier, or a combination thereof of a respective subject type identifier, etc.). In some embodiments, the client application is configured to display a user interface that presents an assigned, or placed, indexed position in the plurality of indexed positions. In some embodiments, the client application is configured to display a user interface that allows the end-user to modify the virtual queue 206, such as remove a respective indexed position. In some embodiments, the client application is configured to display a user interface that includes information about a present location, such as a first present location of a sales associate, a second present location of a customer, a third present location of a POS device, a fourth present location of an available fitting room assigned to the end-user for facilitating an inspection of a respective product (e.g., block 410 of FIG. 4), or a combination thereof. In some embodiments, the client application is configured to display a user interface including an estimated period of time until the customer will be served by a sales associate or is able to facilitate the inspection.

In some embodiments, the client application 306 includes a shared data 310, which includes data elements (e.g., a set of data elements) that is utilized by more than one client device 300 and/or the server 200. For instance, in some embodiments, the shared data 310 is associated with the client identifier 214, such that the shared data 310 is communicated to a client device upon an evaluation of the client identifier 214. By way of example, in some embodiments, the shared data 310 includes information association with the bin 308 of the client identifier 214, allowing the user to access the bin 308 from any one client device 300. However, the present disclosure is not limited thereto.

In some embodiments, the client device 300 includes a GPS driver 330. The GPS driver 330 utilizes data from the GPS 372 providing a current location of the client device 300. In some embodiments, the current location of the client device 300 includes one or more GPS coordinates of the client device 300 (e.g., a latitude coordinate and/or a longitude coordinate), an elevation coordinate of the client device, a tolerance of the current location (e.g., within a range of ±65 seconds of a provided GPS coordinate), data associated with the location identifier of the respective client device 300, or a combination thereof.

In some embodiments, the client device 300 has any or all of the circuitry, hardware components, and software components found in the system depicted in FIG. 3. In the interest of brevity and clarity, only a few of the possible components of the client device 300 are shown to better emphasize the additional software modules that are installed on the client device.

Now that details of an integrated system 100 for providing a virtual queue 206 and/or an authorization of a purchase service have been disclosed, details regarding a flow chart of processes and features for implementing a method 400 for facilitating authorization of a purchase of a product 224, in accordance with an embodiment of the present disclosure, are disclosed with reference to FIG. 4.

Block 402. Referring to block 402 of FIG. 4, a computer implemented method 400 is provided. The method 400 is implemented at a device (e.g., client device 300). The client device 300 includes a display (e.g., display 376 of FIG. 3), an objective lens, and a two-dimensional pixelated detector in communication with the objective lens (e.g., optical sensor 368 of FIG. 3).

The objective lens is configured to collect light in order to capture an image of a first product 224-1. In some embodiments, the objective lens is selected from the group consisting of a three dimensional (3D) binocular, a fiber optic, a fisheye lens, a macro lens, a microscopic lens, a normal lens, and a telephoto lens. Accordingly, the objective lens provides image collection and, optionally, optical zoom functionality together with the two-dimensional pixelated detector for the client device 300. In some embodiments, the objective lens is fixed with respect to a location of the client device 300 (e.g., on a front end portion of a housing of the client device 300).

The client device 300 further includes one or more processors (e.g., processor 392 of FIG. 3), and memory (e.g., memory 307 of FIG. 3) storing one or more programs (e.g., application store 306 of FIG. 3) for execution by the one or more processors 392.

As such, the method 400 requires a computer (e.g., server 200 and/or client device 300) to be used because the utilizations and processes provided by the device cannot be mentally solved.

Block 404. Referring to block 404, the method 400 includes receiving a selection of a first product (e.g., first product 224-1 of FIG. 2B) in a plurality of products 224. For instance, in some embodiments, the plurality of products 224 is associated with a corresponding product database (e.g., product database 220 of FIG. 2A) and/or a corresponding product catalog (e.g., product catalog 222 of FIG. 2B), which provides a universe of products 224 for a respective user to select from. However, the present disclosure is not limited thereto.

For instance, in some embodiments, the selection of the first product 224-1 is based on an evaluation of an image captured by the two-dimensional pixelated detector (e.g., optical sensor 368 of FIG. 3). Referring briefly to FIGS. 6, 8, 9, and 10, a user interface of a client application 306 is provided, in which the user interface 600 is configured to prompt the user to capture an image of a respective product 224 to place the respective product in a bin 308 (e.g., “SCAN & BAG ITEMS” prompt of FIG. 6). Accordingly, in some such embodiments, the image of the respective product 224 depicts a portion of the respective product 224. By way of example, in some embodiments, the portion of the respective product 224 includes a surface of a garment and/or a tag associated with the respective product 224, such as a universal product code (UPC), a quick response code (QR code), a near field communication tag (NFC tag), or a combination thereof. From this evaluation of the image, the first product 224-1 is placed in a bin (e.g., bin 308 of FIG. 3) of one or more products 224 associated with a corresponding client identifier 214 in a plurality of client identifiers.

In some embodiments, a user at the client device 300 provides the receiving of the selection of the first product 224-1, such as by controlling the client device. For instance, in some embodiments, the client device 300 is publicly available, or selectively available to users, allowing more than one user to utilize the client device 300 for an authorization of a purchase of the first product 224-1. In some embodiments, the user provides the selection of the first product 224-1 through an input mechanism (e.g., input 378 of FIG. 3) of the client device 300. For instance, in some embodiments, the selection of the first product 224-1 is provided through a user interface displayed on the display 376 of the client device 300 (e.g., graphical icon 800-2 associated with adding a product 224 to the bin 308), such as by browsing a product catalog 222 presented on the display 376 of the client device 300. However, the present disclosure is not limited thereto.

In some embodiments, the receiving of the selection of the first product 224-1 further includes displaying, on the display 376 of the client device 300, a corresponding plurality of catalog information associated with the first product 224-1. Referring briefly to FIG. 11, in some embodiments, the evaluation of the image includes presenting (e.g., using display 376 of FIG. 3), a user interface of a client application 306 that is configured to display a plurality of catalog information, such as one or more corresponding stock unit variants of the first product 224-1 based on a corresponding stock unit identifier of the first product 224-1. By way of example, if the user captures an image of the first product 224-1 that is a size Medium, the user is allowed to select a different stock unit variant, such as a Small or Large variant, of the first product 224-1. In some embodiments, the plurality of catalog information associated with the first product 224-1 includes a price of the first product 224-1, one or more SKUs (shop keeping units) of the first product 224-1 (e.g., available colors of the first product 224-1, available sizes of the first product 224-1, etc.), one or more physical locations 800-1 having the first product 224-1, an availability the first product 224-1, a corresponding stock unit identifier of the first product 224-1 and the like. In some embodiments, the displaying the corresponding plurality of catalog information is in response to the selection of the first product 224-1 at the client device 300. However, the present disclosure is not limited thereto.

In this way, in some embodiments, the bin 308 retains, in electronic form, the unique selection of products for the user associated with the corresponding client identifier 214. For instance, in some embodiments, the client device 300 allows the user to store the selection of one or more products 224 in the bin 308. In some embodiment, the one or more products 224 selected by the user is stored in the memory 307 on the client device 300, in the memory 192 of the server, both the client device 300 and the server 200 (e.g., as shared data 310). In this way, in some embodiments, after adding the one or more products 224 to the bin 308 (e.g., using the client device 300), the user is able to facilitate a physical inspection of at least a respective product 224 in the one or more products 224 (e.g., block 410 of FIG. 4), request authorization of a purchase of the one or more products 224 (e.g., block 412 of FIG. 4), complete the purchase, or a combination thereof at the client device 300.

In some embodiments, the receiving further includes displaying, on the display 376, and in response to the selection of the first product 224-1, a second product 224-2 associated with the first product (e.g., associated through product association module 226 of FIG. 2B). In some embodiments, the association of the second product 224-2 with the first product 224-1 is based on a predetermined association (e.g., stored by the product association module 226 of FIG. 2B) that is configured by a human subject, such as a sales associate. In some embodiments, a user at the server 200 provides the predetermined association between the first product 224-1 and the second product 224-2, such as in promotion of a promotional campaign. In some embodiments, the association of the second product 224-2 with the first product 224-1 is based on a determination of a respective client preference for the second product 224-2 (e.g., generated by the product association module 226 of FIG. 2B using one or more computational models). For instance, in some embodiments, the association of the second product 224-2 with the first product 224-1 is determined based at least in part on a respective user preference for the second product 224-2, such as a preference for an attribute shared by the first product 224-1 and the second product 224-2. In some embodiments, the association of the second product 224-2 with the first product 224-1 is based on a number of products in the bin 308, a size of the first product 224-1, a mass of the first product 224-1 (e.g., a weight of the first product 224-1), a fragility of the first product 224-1, a color of the first product 224-1, a material of the first product 224-1, a monetary value of the first product 224-1, or a combination thereof, which allows for an optimization and/or balancing of one or more attributes when determining the association of the second product 224-2 with the first product 224-1. In some embodiments, the association of the second product with the first product is determined based on an expected profit, a net profit, a gross profit, or a combination thereof. For instance, in some embodiments, the association with the first product 224-1 is used to promote the second product 224-2, in which the second product 224-2 has a higher profit margin in comparison to the first product 224-1. For instance, if a store would make a first profit of $10 on the purchase by the user of a first product 224-1 and a second profit of $120 on the purchase of the second product 224-2, the method 400 associates with the second product with the first product 224-1 and presents the second product 224-2 to the user to increase profits for the store. However, the present disclosure is not limited thereto.

In some embodiments, the displaying of the second product 224-2 includes displaying on the display 376 a corresponding plurality of catalog information associated with the second product 224-2, such as one or more corresponding stock unit variants of the second product 224-2. For instance, referring briefly to FIG. 9, in some embodiments, a second product 224-2 and a third product 224-3 are presented through a user interface of a client application 306 based on an evaluation of an image of a UPC tag of the first product 224-1 captured by the two-dimensional pixelated detected using light obtained through the objective lens in communication with the two-dimensional pixelated detector. In the present embodiment, a first corresponding plurality of catalog information associated with the second product 224-2 is presented that includes a color of the second product 224-2 (e.g., “Lychee” color) and a size of the second product (e.g., “1×” size) and a second corresponding plurality of catalog information associated with the second product 224-2 is presented that includes description of the third product 224-3 (e.g., “Summer Vibin′” description) and a fit of the second product (e.g., “M[edium] Tall” fit). From this, the user at the client device 300 is provided information associated with the second product 224-2 through the display 376, such as a price of the second product 224-2 and/or a physical location of the second product 224-2, allowing the user to consider the second product 224-2 for purchase and/or selecting the second product 224-2 for inclusion in the bin 308. However, the present disclosure is not limited thereto.

In some embodiments, the user of the client device 300-1 is unassociated with the physical location of the client device 300-1. An example of such an embodiment is an instance where a consumer user interacts with a publicly available client device 300-1 at the physical address (e.g., a kiosk type client device 300 disposed within the physical address). However, the present disclosure is not limited thereto. In some embodiments, the user of the client device 300-1 is associate with the physical location of the client device 300-1, such as a sales associate user of the physical location that operates a POS client device 300.

As such, the method 400 requires a computer (e.g., server 200 and/or client device 300) to be used because receiving the selection of the first product and/or the evaluating of the image provided by or at the computer cannot be mentally solved. In other words, given an input of the selection and/or the evaluating, the output needs to be determined using a computer rather than mentally in such embodiments.

Block 406. Referring to block 406 the method 400 includes receiving a first request (e.g., in electronic form) to purchase each product 224 in the one or more products 224 of the bin 308. For instance, in some embodiments, after viewing a first product 224-1 (e.g., via user interface of client application 306 on display 376 of client device 300, in-person at a retail store, etc.), the user may then select the first product 224-1, thereby assigning the first product to the bin 308-1. In some embodiments, the first request includes a request for an inspection of the first product 224-1 in the one or more products 224-1. Referring briefly to FIG. 13, in some embodiments, a user interface 1300 of a client application 306 is presented on a display 376 of the client device 300. Moreover, the first request to purchase each product 224 is provided through an input mechanism of the client device 300 (e.g., user interface 374 of FIG. 3, input 378 of FIG. 3, etc.). For instance, in some embodiments, the user interface 1300 includes a first mechanism 1302 that allows the user of the client device 300 to communicate the first request to purchase each product 224 of the bin 308 with the requirement to the inspection (e.g., radio button 1302 to “TRY ON IN FITTING ROOM” before purchasing the first product 224-1). However, the present disclosure is not limited thereto. For instance, in some embodiments, the input mechanism includes a mechanical or electrical switch of the client device 300.

Block 408. Referring to block 408, the method 400 includes communicating a second request for placement in a virtual queue (e.g., virtual queue 206 of FIG. 2A) that is stored in a memory (e.g., memory 192 of FIG. 2A) of the server 200. In some embodiments, the second request to purchase the one or more products 224 is communicated to a second client device 300-2 (e.g., as opposed to or in addition to the server 200). However, the present disclosure is not limited thereto. In some embodiments, this communicating of the second request is in response to the receiving selection of the first product 224-1. However, the present disclosure is not limited thereto. In some embodiments, the second request includes a corresponding location identifier associated with a physical address (e.g., location identifier 208 of FIG. 2A) of the one or more products. In some embodiments, the second request further includes a corresponding stock unit identifier for each product 224 in the one or more products 224 of the bin 308. In some embodiments, the corresponding stock unit identifier for each product 224 is retrieved from a product database (e.g., product database 220 of FIG. 2B) associated with the physical location. However, the present disclosure is not limited thereto. In some embodiments, the second request includes a transaction identifier of the request to purchase each product 224 in the one or more products 224 of the bin 308. In this way, the request is uniquely identified through the transaction identifier. Moreover, a future authorization of a purchase of the one or more products 224 is traced to the request through the transaction identifier. In some embodiments, the transaction identifier of the communicating the request to purchase each product 224 includes a plurality of financial information associated with the user of the device, such as a credit of the user.

In some embodiments, the second request in response to receiving financial information associated with a user at an input mechanism of the client device 300 (e.g., input 378 of FIG. 3, input/output subsystem of FIG. 3), such as a magnetic swipe input mechanism, a fingerprint reader input mechanism, an RF near field communication input mechanism, a chip-and-pin input mechanism, and the like. However, the present disclosure is not limited thereto.

As such, the method 400 requires a computer (e.g., server 200 and/or client device 300) to be used because communicating the second request responsive to receiving the first request provided by or at the computer cannot be mentally solved. In other words, given an input of the first request, the output needs to be determined using a computer rather than mentally in such embodiments.

Block 410. Referring to block 410, the method 400 includes facilitating the inspection of the first product 224-1. The inspection of the first product 224-1 allows a subject to physically inspect (e.g., view, hold, wear, etc.) the first product 224-1 before purchase of the first product 224-1, to ensure the first product 224-1 satisfies the needs of the user. By way of example, consider a first user that is a sales associate requiring an inspection of the first product 224-1 in order to remove one or more security mechanisms disposed on the first product 224-1. As another non-limiting example, consider a second user that is a consumer requiring the inspection of the first products 224-1 in order to ensure the first product 224-1 coordinates with an outfit of products 224. As yet another non-limiting example, consider the first request includes the first product 224-1 that the user has required to inspect and try on and a second product 224-2 that is designated to be shipped to a physical address associated with the user. However, the present disclosure is not limited thereto.

In some embodiments, the method 400 facilitates the inspection of the first product 224-1 in accordance with a determination that the respective indexed position satisfies each threshold condition in a plurality of threshold conditions. In some embodiments, the plurality of threshold conditions include a first threshold condition that is satisfied when the first product 224-1 is available for purchase at the physical location associated with the virtual queue 206 (e.g., the selected size, color, fit, or a combination thereof of the first product 224-1 is available). In some embodiments, the plurality of threshold conditions include a second threshold condition that is satisfied when an identity of the user is verified, such as by the server 200 or a human subject at the physical location (e.g., a sales associate), which ensures the correct user inspects the first product 224-1. In some embodiments, this verification is performed by evaluating an identification card associated with the user (e.g., a government issued identification card) or a user profile associated with the user. Furthermore, in some embodiments, the plurality of threshold conditions include a third threshold condition that is satisfied when the quality of first product 224-1 is deemed satisfactory (e.g., the first product 224-1 is deemed by a sales associate to be in suitable condition for purchase, such as having one or more hems, lacking damage, presentation issues, etc.). However, the present disclosure is not limited thereto. For instance, in some embodiments, the plurality of threshold conditions includes a fourth condition that is satisfied when the frequency of requests for the user is greater than a predetermined frequency, in order to deter consumers from consistently purchasing and then returning a set of products 224.

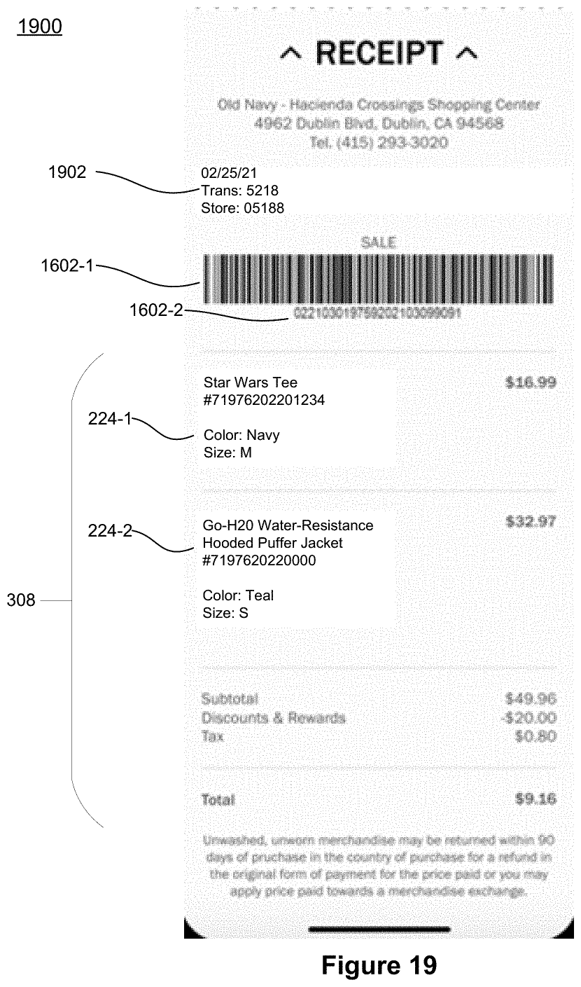

In some embodiments, prior to facilitating the inspection of the first product (e.g., block 402, block 404, block 406, block 408 of FIG. 4), during the inspection of the first product, after the inspection of the first product (e.g., block 412 of FIG. 4), or a combination thereof the bin 308 is a digital shipping bin (e.g., bin 308 of FIG. 9, bin 308 of FIG. 10, bin 308 of FIG. 12, bin 308 of FIG. 17, bin 308 of FIG. 19, etc.) that includes the one or more products 244 the user of the client device 300 has selected, which indicates a desire by the user to purchase the one or more products 224. Furthermore, in some such embodiments, prior to facilitating the inspection of the first product, during the inspection of the first product, after the inspection of the first product, or the combination thereof the bin 308 is utilized to form a physical realization of a set of products in the one or more products 224 of the bin 308. In some such embodiments, the set of products includes some or all of the one or more products in the bin 308. In some embodiments, the physical realization of the set of products is an item or service that is convenient to the user (e.g., an in-person exchange of a box and/or a bag, via shipping courier, etc.). By way of example, in some embodiments, a first set of products 224 in the one or more products 224 of the bin 308 is delivered using a physical accommodation (e.g., the box and/or the bag) to a respective fitting room for inspection by the user. However, the present disclosure is not limited thereto.

Furthermore, in some embodiments, the plurality of threshold conditions include a fifth condition that is satisfied when the respective indexed position associated with the corresponding client identifier of the user is equal to or greater than a predetermined position, such as an initial position or top ten position. In some embodiments, the predetermined position is based on a number of fitting rooms at the physical location, a number of available fitting rooms at the physical location, a number of POS devices at the physical location, a number of available POS devices at the physical location, and the like. In this way, the virtual queue 206 provides a hierarchy for an order of facilitating an inspection of a respective product 224, which ensures that the user does not waste time looking for a sales associate and/or an available fitting room to inspect the first product 224-1.

As such, the method 400 requires a computer (e.g., server 200 and/or client device 300) to be used because determining if each threshold condition is satisfied provided by or at the computer cannot be mentally solved. In other words, given an input of a respective indexed position of the virtual queue, the output needs to be determined using a computer rather than mentally in such embodiments.

Block 412. Referring to block 412, the method 400 includes receiving an authorization of the first request to purchase each product 224 in the one or more products 224 of the bin 308. In some embodiments, this receiving of the authorization of the first request is in response to the facilitating the inspection of the first product 224-1. From this, an authorization for purchase of the first product 224-1 is provided at the client device 300. For instance, in some embodiments, the authorization of the first request includes initiating a purchase request, receiving a payment, authorizing the payment, charging a payment amount, charging a credit account, completing a sale transaction, a capacity of a physical address, a spatial dimension associated with a set of products in the one or more products of the bin, or a combination thereof. In some embodiments, by providing an authorization for purchase of the first product 224-1 based on the selection of the first product (e.g., block 404 of FIG. 4), a user at the client device facilitates pre-purchase of the first product 224-1 without interacting with a sales associate at the physical location of the first product 224-1, such as requesting to try on the first product 224-1, trying on the first product 224-1, purchasing the first product 224-1, or a combination thereof. Thus, when the sales associate is available to facilitate assisting the user, such as by facilitating a purchase of the one or more products 224 of the bin 308, the purchase of the one or more products 224 is pre-authorized or authorized, reducing contact between the user of the client device 300 and the sales associate. In some embodiments, the user of the client device 300 is provided with a confirmation of the authorization prior to the purchase of each product 224 in the one or more products 224 of the bin 308. In this way, the user can cancel the authorization for the purchase of the one or more products 224 of the bin 308 before purchasing the one or more products 224. For instance, referring briefly to FIG. 16, a user interface 1600 of a client application 306 is displayed on a display 376 of a client application 300, in which the user interface 1600 includes a UPC generated by the client device 300 and/or the server 200, such that the user is allowed to complete the transaction by presenting the UPC to a sales associate. Additionally, in some embodiments, the authorization for purchase of the one or more products 224 of the bin 308 further includes a purchase of each product 224 in the one or more products 224. In this way, the present disclosure allows for the user at the client device 300 to facilitate an entire purchase process of selecting and buying a first product 224-1 from a respective client device 300 associated with the user through a client identifier 214.

In some embodiments, the purchase authorization for the one or more products 224 of the bin 308 is associated with the corresponding location identifier 208 associated with the physical address of the one or more products 224. In this way, the user at the client device 300 can receive purchase authorization of the one or more products 224 at the physical address without being present (e.g., location within a building) at the physical address.

### Example 1: Facilitating and Updating a Virtual Queue

In some embodiments, the present disclosure is directed to providing a computer implemented system and method at a server (e.g., server 200 of FIG. 1, server 200 of FIGS. 2A and 2B, etc.) is provided. The server 200 stores a virtual queue (e.g., virtual queue 206 of FIG. 2A) in a memory (e.g., memory 307 of FIG. 2A) of the server 200. In some embodiments, the virtual queue 206 of the present disclosure cannot be mentally performed.

The virtual queue 206 includes a corresponding location identifier (e.g., location identifier 208 of FIG. 2A) that is associated with a physical address. In some embodiments, the physical address is remote from the server, such that the server 200 does not share the same physical address as the virtual queue 206. By way of example, in some embodiments, the physical address includes a mailing address associated with a brick-and-mortar store. However, the present disclosure is not limited thereto. In some embodiments, by associating the virtual queue 206 with the location identifier 208, a user of a client device (e.g., client device 300 of FIG. 1, client device 300 of FIG. 3, etc.) is allowed to request an update for the virtual queue 206 based on a further association between the user and the physical address of the location identifier 208, such as a threshold proximity to the physical address of the location identifier 208. For instance, in some embodiments, a client device 300 identified as being at the physical address, allowing the client device 300 to communicate with the virtual queue 206 through the location identifier 208 associated with the physical address. However, the present disclosure is not limited thereto.

In some embodiments, the virtual queue 206 includes a record of a plurality of indexed positions (e.g., record of indexed positions 210 of FIG. 2A) that retains a listing of one or more indexed positions (e.g., second indexed position 212-2 of FIG. 2A). Each respective indexed position 212 in the plurality of indexed positions 212 includes a corresponding client identifier in a plurality of client identifiers (e.g., client identifier 214 of FIG. 2A). Each respective client identifier 214 in the plurality of client identifiers 214 is associated with at least one corresponding client device 300 in a plurality of client devices 300. In this way, the association between a corresponding client device 300 and a respective indexed position 212 through the client identifier 214 allows a user to modify a corresponding client device 300 associated with the client identifier 214 and receive updates from the modified corresponding client device 300 without modifying the respective indexed position 212. From this, the user retains the respective indexed position 212 irrespective of the corresponding client device 300. By way of example, consider a user that logs into a client application (e.g., client application 306 of FIG. 3) configured to facilitate a virtual queue 206 in coordination with a server 200, in which the client application is executed at a first client device 300-1 and forms an association with the virtual queue 206 through a corresponding client identifier 214 of the user by logging into the client application 306. If the user logs into the client application 306 at a second client device 300-2, the association with the virtual queue 206 through the corresponding client identifier 214 of the user is formed at the second client device 300-2, allowing the user to communicate with the virtual queue 206 from either of the first client device 300-1 or the second client device 300-2. Moreover, this allows for the user to receive an update for a respective indexed position 212 at each of the one corresponding client devices 300 associated with the corresponding client identifier 214, ensuring the user receives the update for the respective indexed position 212. For instance, referring briefly to FIG. 7, a first position identifier 218-1 indicates that a first client device 300-1 is at a fourth position in the virtual queue 206. In some embodiments, the position identifier 218 correlates to a hierarchy of the indexed position 212 within the record of indexed positions 210 (e.g., the fourth position is the fourth indexed position 212-4). However, the present disclosure is not limited thereto.

Additionally, in some embodiments, the virtual queue 206 includes a position identifier (e.g., position identifier 218 of FIG. 2A) associated with a corresponding indexed position in the plurality of indexed positions 212 of the virtual queue. In some embodiments, the position identifier 218 is utilized to indication a position of the corresponding client identifier 214 associated with a respective indexed position in the virtual queue 206. For instance, if a first user associated with an initial indexed position 212-1 is with a sales associate at the physical location but has not yet been removed from the virtual queue 206 (e.g., the sales associate communicates an update to the virtual queue 206 include a request to remove the user from the virtual queue), a second user associated with a second indexed position 212-2 has a corresponding position identifier 218 that indicates an initial position in the virtual queue.

In some embodiments, the record of indexed positions 210 further includes a corresponding location identifier (e.g., location identifier 208 of FIG. 2A) associated with a corresponding client device 300 for each corresponding client device 300 in the at least one corresponding client devices 300. In this way, the record of indexed positions 210 retains indexed positions 212 for more than one location identifier 208. However, the present disclosure is not limited thereto. In some embodiments, the association between a respective client identifier 214 and the at least one corresponding client device 300 includes an electronic address (e.g., electronic address 304 of FIG. 3) of a corresponding client device 300 in the at least one corresponding client device 300.

In some embodiments, each respective indexed position 212 in the plurality of indexed positions 212 further includes a respective subject type identifier 216 in a plurality of subject type identifiers 216. In this way, a respective indexed position 212 is further categorized by subject type identifier 216. In some embodiments, the subject type identifiers 216 allow for a user of a client device 300 receiving information association with the respective indexed position 212 to ascertain information associated with a reasoning for placement in the record of indexed positions 210. For instance, in some embodiments, the plurality of subject identifiers 216 includes an inquiry type identifier (e.g., a first subject type identifier 216-1 associated with an inquiry type of a client), a purchase order type identifier (e.g., a second subject type identifier 216-2 associated with a request for an authorization of a purchase of a first product 224-1), a return order type identifier (e.g., a third subject type identifier 216-3 associated with a prior purchase of a second product 224-2), an inspection order identifier (e.g., a fourth subject type identifier 216-4 associated with a request to inspect a first product, e.g., method 400 of FIG. 4), or a combination thereof. In this way, users are placed in the virtual queue 206 based on categorization of a respective subject type identifier 216, allowing for the virtual queue 206 to order the users within the record of indexed positions based on the subject type identifier 216 and/or an order of receipt for a corresponding request to update the virtual queue 206.

In some embodiments, the purchase order type identifier 216 includes a listing of a transaction identifier associated with the corresponding client identifier 214, such as a prior purchase of a product 224 by a user associated with the corresponding client identifier 214. In some embodiments, the purchase order type identifier 216 includes each product 224 in the one or more products 224 of a bin 308 associated with the corresponding client identifier 214.

In some embodiments, each respective subject identifier 216 includes a corresponding weight associated with a modification in the position identifier associated with the corresponding position in the plurality of indexed positions. In some embodiments, the corresponding weight associated with the modification in the position identifier is independently assigned. For instance, in some embodiments, the purchase order type identifier 214 includes a first weight that is greater than a second weight for the inquiry type identifier 216 or a third weight for the return order type identifier 216. In this way, the purchase order type identifier 216 is provided with a higher precedent, or a placement within the virtual queue 206, in comparison to the inquiry type identifier 216 or the return order type identifier 216. As another non-limiting example, a first request to inspect a respective product 224 associated with a first user that is conducting an inspection of a first product 224-1 (e.g., trying on the first product 224-1) is provided with a higher precedent, or placement within the virtual queue, in comparison to a second request to inspect the respective product 224 associated with a second user that has not yet to conduct the inspection. However, the present disclosure is not limited thereto. For instance, as described supra, in some embodiments, the placement within the virtual queue 206 is based on an order of receipt for an update requesting inclusion in the virtual queue 206 (e.g., block 404 of FIG. 4).

In some embodiments, an update for the virtual queue 206 is received (e.g., through communication network 106) at the server 200. In some embodiments, the update includes modifying the record of the plurality of indexed positions 210 to indicate a change in at least one position identifier 218 associated with the update. From this modification, the record of the indexed positions 210 is updated to reflect the change in the at least one position identifier 218. In some embodiments, the change in the at least one position identifier includes a change in an initial indexed position 212, a final indexed position 212, or both. For instance, referring briefly to FIG. 14, in some embodiments, after facilitating the inspection of the first product (e.g., block 410 of FIG. 4), a user interface 1400 of a client application 306 is displayed on a display 375 of the client device 300. In some embodiments, the user interface 1400 includes one or more input mechanisms (e.g., buttons 1302, 1404, 1406) that allow the user to modify the bin using a third button 1406, communicate a further first request (e.g., reiterate block 404 of FIG. 4 for a third product 224-3) using a first button 1402, communicate a third request to purchase the first product 224-1, and the like.

In some embodiments, the change in the at least one position identifier 218 includes an increase in position of a respective position identifier 218 in the at least one position identifier 218 and/or a decrease in position of the respective position identifier 218. By way of example, in some embodiments, the increase in position of the respective position identifier 218 occurs in response to a first indexed position 212-1 in the record of indexed position 210 assisted by a sales associate user at the physical location. However, the present disclosure is not limited thereto. In some embodiments, the change in the at least one position identifier 218 includes removal of a respective position identifier 218 in the at least one position identifier 218.

In some embodiments, the method includes communicating the update for the record of the indexed positions 210 to a first client device 300-1 in the plurality of client devices 300. In some embodiments, the communicating the update for record of the indexed positions 210 is in response to a request for the change in the at least one position identifier from the first client device 300-1 in the plurality of client devices 300. By way of example, if a sales associate user finalizes an authorization of a purchase for a first product 224-1 with a first user associated with a first client identifier 214-1 of an initial indexed position 212 and requests removal of the initial indexed position 212 from the virtual queue 206, the server 200 communicates to the sales associate user an update to the virtual queue 206 for a modified initial indexed position (e.g., a second indexed position 212-2 associated with a second client identifier 214-2 of a second user that is modified to become the initial indexed position 212).

In some embodiments, the communicating the update for the record of the indexed positions 210 is in response to a command provided by the server 200 to the first client device 300-1. In this way, the server 200 can push the update for the record of the indexed positions 210 to the first client device 300. By way of example, in some embodiments, if the first client device 300-1 is associated with a sales associate user, then the server 200 communicates a proceeding indexed position 212 to the first client device 300-1 or each indexed position 212 of the record of indexed positions 210. In other embodiments, if the first client device 300-1 is associated with a consumer user, then the server 200 communicates a respective indexed position 212 associated with a corresponding client identifier 214 of the consumer user. However, the present disclosure in not limited thereto.

In some embodiments, the communicating the update for the record of the indexed positions 212 is conducted in accordance with a determination of an available bandwidth of the physical location associated with the corresponding location identifier 208. In some embodiments, the available bandwidth includes a first limit associated with a capacity of the physical address, such as a maximum occupancy of subjects inside the physical address. In some embodiments, the first client device 300-1 provides the capacity of the physical address, such that the first client device 300-1 can configure the capacity of the physical address. However, the present disclosure is not limited thereto. In some embodiments, a spatial dimension associated with the physical address, such that the capacity changes based on the spatial dimension associated with the physical address, defines the capacity of the physical address. In some embodiments, the spatial dimension associated with the physical address includes a size of an area associated with the physical address, such as a volume associated with the physical address or a surface area associated with the physical address (e.g., a floor plan of the physical address). In this way, the update for the record of the indexed positions 212 is communicated to the first client device 300-1 based on a determination that the available bandwidth (e.g., capacity) of the physical address is greater than zero, such that a user associated with the first client device 300-1 can engage the physical location (e.g., purchase a first product 224-1 at the physical location) due the available bandwidth. However, the present disclosure is not limited thereto.

In some embodiments, the communicating the update for the record of indexed positions 210 includes communicating the corresponding client identifier 214 for each respective position in the plurality of indexed positions 212. For instance, in some embodiments, the communicating the corresponding client identifier 214 for each respective position in the plurality of indexed positions 212 includes providing a listing the corresponding client identifier 214 and a respective indexed position 212. By way of example, the server 200 communicates to the first client device 300-1 a listing of a first user associated with a first client identifier 214-1 of an initial indexed position 212-1, a second user associated with a second client identifier 214-2 of a second indexed position 212-2, and a third user associated with a third client identifier 214-3 of a final indexed position 212-3. From this, a user at the first client device 300-1 (e.g., a sales associate user) can visualize the corresponding client identifier 214 for each respective position in the plurality of indexed positions 212 and attend to the virtual queue 206 based on this visualization. However, the present disclosure is not limited thereto. In some embodiments, the communicating the update for the record of indexed positions 210 includes communicating the corresponding client identifier for the first client device 300-1. In some embodiments, the server 200 communicates a corresponding client identifier 214 for each respective position in the plurality of indexed positions 212 that is associated with a corresponding subject type identifier 216. As a non-limiting example, the server 200 communicates to the first client device 300-1 a listing of each corresponding client identifier 214 for each respective position in the plurality of indexed positions 212 that is associated with a purchase subject type identifier 216. In some embodiments, the server 200 communicates the listing based on a request for the corresponding subject type identifier from the first client device 300-1. In some embodiments, the first client device 300-1 is configured as a point-of-sales device and configured to receive a listing of each corresponding client identifier 214 for each respective position in the plurality of indexed positions 212 that is associated with a purchase subject type identifier 216. However, the present disclosure is not limited thereto.

### Example 2: Facilitating an Inspection and/or Purchase of a First Product

In some embodiments, the present disclosure is directed to providing a computer implemented system and method at a device (e.g., client device 300 and/or server 200) is provided. The client device 300 includes a display (e.g., display 376 of FIG. 3), an objective lens, and a two-dimensional pixelated detector in communication with the objective lens (e.g., optical sensor 368 of FIG. 3). The client device 300 further includes one or more processors (e.g., processor 372 of FIG. 3), and memory (e.g., memory 307 of FIG. 3) storing one or more programs (e.g., application store 306 of FIG. 3, etc.) for execution by the one or more processors 372.

In some embodiments, a selection of a first product (e.g., first product 224-1 of FIG. 2B) in a plurality of products 224 is received in electronic form (e.g., block 404 of FIG. 4). For instance, in some embodiments, the plurality of products 224 is associated with a corresponding product database (e.g., product database 220 of FIG. 2A) and/or a corresponding product catalog (e.g., product catalog 222 of FIG. 2B). Accordingly, in some such embodiments, the plurality of products is an enumerated plurality of products 224.

In some embodiments, the selection of the first product 224-1 is based on an evaluation of an image captured by the two-dimensional pixelated detector (e.g., optical sensor 368 of FIG. 3). From this evaluation of the image, the first product 224-1 is placed in a bin (e.g., bin 308 of FIG. 3) of one or more products 224 associated with a corresponding client identifier 214 in a plurality of client identifiers.

In some embodiments, the receiving of the selection of the first product 224-1 further includes displaying, on the display 376 of the client device 300, a corresponding plurality of catalog information associated with the first product 224-1. Referring briefly to FIG. 8, in some embodiments, the plurality of catalog information associated with the first product 224-1 includes a price of the first product 224-1, one or more skews of the first product 224-1 (e.g., available colors of the first product 224-1, available sizes of the first product 224-1, etc.), one or more physical locations 800-1 having the first product 224-1, an availability the first product 224-1, a corresponding stock unit identifier of the first product 224-1 and the like. In some embodiments, the displaying the corresponding plurality of catalog information is in response to the selection of the first product 224-1 at the client device 300. However, the present disclosure is not limited thereto.

In some embodiments, the receiving further includes displaying, on the display 376, and in response to the selection of the first product 224-1, a second product 224-1 associated with the first product (e.g., associated through product association module 226 of FIG. 2B). In some embodiments, the association of the second product 224-2 with the first product 224-1 is based on a predetermined association (e.g., stored by the product association module 226 of FIG. 2B). In some embodiments, a user at the server 200 provides the predetermined association between the first product 224-1 and the second product 224-2, such as in promotion of a promotional campaign. In some embodiments, the association of the second product with the first product is based on a determination of a respective client preference for the second product 224 (e.g., generated by the product association module 226 of FIG. 2B). In some embodiments, the displaying of the second product 224-2 includes displaying a corresponding plurality of catalog information associated with the second product 224-2. From this, a user at the client device 300 is provided information associated with the second product 224-2, such as a price of the second product 224-2 and/or a physical location of the second product 224-2, allowing the user to consider the second product 224-2 for purchase and/or selecting the second product 224-2 for inclusion in the bin 308. However, the present disclosure is not limited thereto.

In some embodiments, the user of the client device 300-1 is unassociated with the physical location of the client device 300-1. An example of such an embodiment is an instance where a consumer user interacts with a publicly available client device 300-1 at the physical address (e.g., a kiosk type client device 300 disposed within the physical address). However, the present disclosure is not limited thereto. In some embodiments, the user of the client device 300-1 is associate with the physical location of the client device 300-1, such as a sales associate user of the physical location.

In some embodiments, a request for an inspection of the first product 224-1 in the one or more products 224-1 is received (e.g., a first request in electronic form is received at the client device 300 and/or the server 200). Referring briefly to FIG. 12, in some embodiments, a user interface 1200 of a client application 306 is presented on a display 376 of the client device 300. Moreover, a first request to purchase each product 224 is provided through an input mechanism of the client device 300 (e.g., user interface 374 of FIG. 3, input 378 of FIG. 3, button 1302 of FIG. 12, button 1302 of FIG. 13, button 1402 of FIG. 14, etc.). For instance, in some embodiments, the user interface 1300 includes a first mechanism 1302 that allows the user of the client device 300 to communicate the first request to purchase each product 224 of the bin 308 with the requirement to the inspection (e.g., radio button 1302 to “TRY ON IN FITTING ROOM” before purchasing the first product 224-1). However, the present disclosure is not limited thereto. For instance, in some embodiments, the input mechanism includes a mechanical or electrical switch of the client device 300.

In some embodiments, a command to purchase each product 224 in the one or more products 224 of the bin 308 is received (e.g., a command in electronic form received at the server 200 from the client device 300). In some embodiments, the command to purchase each product 224 is provided through an input mechanism of the client device 300 (e.g., user interface 374 of FIG. 3, input 378 of FIG. 3, etc.). For instance, referring briefly to at least FIGS. 9, 12, and 14, in some embodiments, the command to purchase each product 224 in the one or more products 224 of the bin is provided through an input mechanism (e.g., button 1404) of a user interface displayed on the display 376 of the client device 300. However, the present disclosure is not limited thereto. For instance, in some embodiments, the input mechanism includes a mechanical or electrical switch (e.g., switch 802) of the client device 300.

In some embodiments, a request to purchase each product 224 in the one or more products 224 of the bin 308 is communicated to the service to a server (e.g., server 200 of FIG. 1, server 200 of FIGS. 2A and 2B). In some embodiments, the request includes a request for placement in a virtual queue 206 of a server 200. In some embodiments, the request to purchase the one or more products 224 is communicated to a second client device 300-2 (e.g., as opposed to or in addition to the server 200). However, the present disclosure is not limited thereto. This communicating of the request is in response to the command to purchase each product 224 of the bin 308. The request includes a corresponding location identifier associated with a physical address (e.g., location identifier 208 of FIG. 2A) of the one or more products. The request further includes a corresponding stock unit identifier for each product 224 in the one or more products 224 of the bin 308. In some embodiments, the corresponding stock unit identifier for each product 224 is retrieved from a product database (e.g., product database 220 of FIG. 2B) associated with the physical location. However, the present disclosure is not limited thereto. The request includes a transaction identifier of the request to purchase each product 224 in the one or more products 224 of the bin 308. In this way, the request is uniquely identified through the transaction identifier. Moreover, a future authorization of a purchase of the one or more products 224 (e.g., method 400 of FIG. 4) is traced to the request through the transaction identifier. In some embodiments, the transaction identifier of the communicating the request to purchase each product 224 includes a plurality of financial information associated with the user of the device, such as a credit of the user.

In some embodiments, the shared data 310 includes the transaction identifier (e.g., transaction identifier 1902 of FIG. 19). For instance, in some embodiments, in some embodiments, the shared data element includes a transaction identifier of a procurement transaction that was executed by a first client application of a first client device that is then retrieved by a second client application on a second client device using the shared data. However, the present disclosure is not limited thereto. For instance, in some embodiments, the first application 306-1 forms a first shared data associated with a first user interaction locally at a first client device 300-1 (e.g., a first transaction identifier is created at the first client device 300) and the second application 306-2 forms a second shared data associated with a second user interaction at a second client device 300-2 (e.g., a second transaction identifier is created at the second client device 300). This first shared data and second shared data are then communicated to server 200 and collectively stored as shared data element 310, which is then read by the first application 306-1 and/or the second application 306-2, or a third application of a third client device, allowing for the first client device 300-1, the second client device 300-1, the third client device, or a combination thereof to access both of the first data and the second data using the shared data 310. However, the present disclosure is not limited thereto. As another example, in some embodiments, a first transaction identifier is created at the first client device 300 using a first application 306-1 and the first transaction identifier is communicated to the server 200, such that the first transaction identifier is retained through the shared data 310. In this way, a second client device 300-2 7 utilizing a second application 306-2 can access the first transaction identifier through the shared data element 310. Moreover, the first client device 300-1 can also access the first transaction identifier through the shared data element 310 using the second application 306-2 at the first client device 300-1. In some embodiments, the first application 306 is configured for use by a first end-user that is a consumer and the second application 306 is configured for use by a second end-user that is a sales associate. However, the present disclosure is not limited thereto. In some embodiments, each respective application provides an ability to read and/or write transaction identifiers (e.g., shared data element 310) on a table stored at a corresponding client device 300 running the application and/or the server 200, such that multiple devices can perform transactions and provide transaction data. In some such embodiments, the shared data 310 includes an AMEX transaction identifier (Transaction ID that AMEX assigns to each transaction), an amount (an amount of the transaction), an authorization code (a code returned by the credit card processor when a transaction is approved), an AVS street match (result of an AVS check for street number and name), an AVS zip code match (result of the AVS check for zip code.), a settlement batch number (e.g., a first value means the transaction has not been settled and any other value indicated the transaction has settled), a billing address (a street address submitted with a transaction), a card security code match, a client IP address (an IP address of the Web server to which the transaction was submitted), a credit card expiration date, a customer code, a description of a procured item, a discount amount (any discount applied to the transaction), a quantity, a shipping address, a shipping method, a shipping phone number, a tax amount, a tax rate, a tender type (e.g., type of credit card used for the transaction), a time stamp (a date and time that the transaction occurred), or a universal pricing code (a string describing the products for a line item in a transaction) for a procurement transaction that was executed by the first application. Accordingly, in some embodiments, the transaction identifier is associated with a procurement transaction. However, the present disclosure is not limited thereto.

In some embodiments, the request to purchase each product 224 in the one or more products 224 of the bin 308 is provided through an input mechanism of the client device 300 (e.g., user interface 374 of FIG. 3, input 378 of FIG. 3, etc.). For instance, referring briefly to at least FIGS. 9, 12, and 14-19, in some embodiments, the request to purchase each product 224 in the one or more products 224 of the bin 308 is provided through an input mechanism (e.g., button 1404 of FIG. 17, button 1404 of FIG. 9, etc.) of a user interface displayed on the display 376 of the client device 300. However, the present disclosure is not limited thereto.

In some embodiments, the request to purchase each product 224 in the one or more products 224 of the bin is in response to receiving financial information associated with a user at an input mechanism of the client device 300 (e.g., input 378 of FIG. 3, input/output subsystem of FIG. 3), such as a magnetic swipe input mechanism, a fingerprint reader input mechanism, an RF near field communication input mechanism, a chip-and-pin input mechanism, and the like.

In some embodiments, an authorization of the request to purchase each product 224 in the one or more products 224 of the bin 308 is received. In some embodiments, the authorization of the request in response to the communicating the purchase request for the one or more products 224. From this, an authorization for purchase of the first product 224-1 is provided at the client device 300. In some embodiments, by providing an authorization for purchase of the first product 224-1 based on the selection of the first product (e.g., block 404 of FIG. 4), a user at the client device facilitates pre-purchase and/or purchase of the first product 224-1 without interacting with a sales associate at the physical location of the first product 224-1. Thus, when the sales associate is available to facilitate a purchase of the one or more products 224 of the bin 308, the purchase of the one or more products is pre-authorized, reducing contact between the user of the client device 300 and the sales associate. In some embodiments, the user of the client device 300 is provided with a confirmation of the authorization prior to the purchase of each product 224 in the one or more products 224 of the bin 308. In this way, the user can cancel the authorization for the purchase of the one or more products 224 of the bin 308 before purchasing the one or more products 224. Additionally, in some embodiments, the authorization for purchase of the one or more products 224 of the bin 308 further includes a purchase of each product 224 in the one or more products 224. In this way, the present disclosure allows for the user at the client device 300 to facilitate an entire purchase process of selecting and buying a first product 224-1 from a respective client device 300 associated with the user through a client identifier 214.

In some embodiments, the purchase authorization for the one or more products 224 of the bin 308 is associated with the corresponding location identifier 208 associated with the physical address of the one or more products 224. In this way, the user at the client device 300 can receive purchase authorization of the one or more products 224 at the physical address without being present (e.g., location within a building) at the physical address.

Referring briefly to FIG. 6, in some embodiments, the systems and methods of the present disclosure provide a user interface 600 of a client application 306 that is displayed on a display 376 of a client device 300. In some embodiments, the user interface 600 is configured to prompt an end-user of the client device 300 to select one or more products to placement in a bin 308 associated with the end-user (e.g., “SCAN & BAG ITEMS”), prompt the end-user to purchase the one or more products in the bin 308 (e.g., “PAY WITH YOUR CARD”), and one or more input mechanisms (e.g., button 602, button 604) that allow the end user to select a respective product by capturing an image associated with the product using button 602, or to sign into a user profile associated with the end user (e.g., for placement in a virtual queue of method 400, example 1, example 2, etc.). However, the present disclosure is not limited thereto. For instance, in some embodiments, a respective input mechanism in the one or more input mechanisms is configured to communicate a request for placement in a virtual queue 206.

Referring briefly to FIG. 8, in some embodiments, the systems and methods of the present disclosure provide a user interface 800 of a client application 306 that is displayed on a display 376 of a client device 300. In some embodiments, the user interface 800 is configured to prompt an end-user to select one or more products 224 for placement in a bin 308 associated with the end-user, such as by capturing an image of a respective product 224 using an objective lens and two-dimensional pixelated detector of the client device 300. By way of example, in some embodiments, the end-user is prompted to capture a first image of a barcode of the respective product 224, which allows the systems and methods of the present disclosure to evaluate the first image to place the respective product 224 in the bin 308 associated with the end-user. In some embodiments, the user interface 800 includes one or more input mechanisms (e.g., button 602) that allow the end user to select a respective product by capturing the image associated with the respective product using button 602. However, the present disclosure is not limited thereto.

Referring briefly to FIG. 9, in some embodiments, the systems and methods of the present disclosure provide a user interface 900 of a client application 306 that is displayed on a display 376 of a client device 300. In some embodiments, the user interface 900 is configured to present a view, or preview, of an image of a first product 224-1 from an objective lens and two-dimensional pixelated detector of the client device 300. In some embodiments, the user interface is configured to present one or more products 224 (e.g., second product 224-2 and/or third product 224-3) that is associated with the first product 224-1. In some embodiments, the user interface 900 includes an input mechanism that is configured to provide (e.g., receive and/or communicate) a request to purchase each product 224 in the one or more products 224 of the bin 308 (e.g., button 1404). However, the present disclosure is not limited thereto.

Referring briefly to FIG. 10, in some embodiments, the systems and methods of the present disclosure provide a user interface 1000 of a client application 306 that is displayed on a display 376 of a client device 300. In some embodiments, the user interface 1000 is configured to present a view, or preview, of an image of a first product 224-1 from an objective lens and two-dimensional pixelated detector of the client device 300. In some embodiments, the user interface 1000 includes one or more input mechanism (e.g., button 1002, button 1004) that allow the end-user to allow and/or remove one or more coupon codes associated with the first product 224-1.

Referring briefly to FIG. 11, in some embodiments, the systems and methods of the present disclosure provide a user interface 1100 of a client application 306 that is displayed on a display 376 of a client device 300. In some embodiments, the user interface is configured for receiving a selection of a first product 224-1 in a plurality of products 224. For instance, in some embodiments, based on an evaluation of an image captured by a two-dimensional pixelated detector of the client device 300, the user interface 1100 is presented on the client device 300. In some embodiments, the user interface 1100 includes one or more input mechanisms (e.g., digital bars, wheels, or buttons 1102 of FIG. 11) that allow the end-user to select one or more variations of the first product 224-1. In some embodiments, respective variations in the one or more variations are each associated with a corresponding stock unit identifier, which allows for an accounting of inventory of the first product 224-1.

Referring briefly to FIGS. 12 and 17, in some embodiments, the systems and methods of the present disclosure provide a user interface (e.g., user interface 1200 of FIG. 12, user interface 1700 of FIG. 17) of a client application 306 that is displayed on a display 376 of a client device 300. In some embodiments, the user interface is configured to present the one or more products selected by an end-user of the client device 300 for placement (e.g., assignment) in a bin 308 associated with the end-user by way of a corresponding client identifier that is associated with both the end-user (e.g., a user profile of the end-user) and the bin 308. By way of example, in the present embodiment, the bin 308 of FIG. 12 includes six products (e.g., first product 224-1, second product 224-2, . . . , sixth product 224-6), each of which the user has selected for placement in the bin 308. In some embodiments, a respective product 224 of the bin is placed in the bin based on an evaluation of the image (e.g., of the respective product 224) captured by the two-dimensional pixelated detector of the client device 300. However, the present disclosure is not limited thereto. Accordingly, in some embodiments, the user interface is configured to present a listing of each product in the one or more products 224 of the bin 308. In some embodiments, the listing further includes a description of a corresponding plurality of catalog information that is associated with a respective product in the one or more products 224 of the bin 308. However, the present disclosure is not limited thereto. For instance, in some embodiments, a respective input mechanism in the one or more input mechanisms of the user interface is configured to communicate a request for placement in a virtual queue 206.

Referring briefly to FIG. 13, in some embodiments, the systems and methods of the present disclosure provide a user interface 1300 of a client application 306 that is displayed on a display 376 of a client device 300. In some embodiments, the user interface 1300 is configured to prompt an end-user to inspect a respective product 224 (e.g., prompt “You can try on your items in a fitting room or see them in the Review Area before paying.”) and provide, using an input mechanism (e.g., button 1302) (e.g., receive in electronic form), a request that includes a requirement for an inspection of the respective product (e.g., first product 224-1) in one or more products of a bin 308. However, the present disclosure is not limited thereto. For instance, in some embodiments, a respective input mechanism in the one or more input mechanisms of the user interface is configured to communicate a request for placement in a virtual queue 206. Furthermore, in some embodiments, the request is a requirement by the end-user that is a consumer, such as to try on a respective product 224 in a fitting room associated with a physical location (e.g., of a virtual queue 206, of a first product 224-1, etc.). However, the present disclosure is not limited thereto. For instance, in some embodiments, the request is a requirement by a subject other than the consumer (e.g., the server 200, a sales associate), such as a request to remove one or more security mechanisms (e.g., prompt and/or button to acknowledge a request for inspection that includes “Some items in your bag may have security tags. An associate can remove them on your way out today.”) (e.g., block 404 of FIG. 4). However, the present disclosure is not limited thereto. In some embodiments, the requirement for inspection of the respective product 224 includes a prompt for the end-user to provide information associated with the end-user, such as to determine if one or more threshold conditions is satisfied including verification of an identity of the end-user (e.g., a first name of the end-user, a last initial or name of the end-user, an electronic address associated with the end-user, etc.), a frequency of requests for the end-user (e.g., to determine if the end-user has already submitted a prior request for inclusion, such as by prompting the end-user to acknowledge if “Already in the Fitting Room? Enter the same name & [electronic address of a phone] number as before.”), a time of day (e.g., to determine if a physical location is approaching closing hours, etc.), or a combination thereof.

Referring briefly to FIG. 14, in some embodiments, the systems and methods of the present disclosure provide a user interface 1400 of a client application 306 that is displayed on a display 376 of a client device 300. In some embodiments, the user interface 1400 is configured to follow-up with an end-user of the client device when receiving a request that includes a requirement for inspection of a respective product 224 (e.g., block 404 of FIG. 4) and/or when facilitating the inspection (e.g., block 410 of FIG. 4). For instance, in some embodiments, the user interface 1400 includes one or more input mechanisms (e.g., digital bars, wheels, or buttons 1102 of FIG. 11) that allow the end-user to select one or more variations of the first product 224-1. In some embodiments, the user interface 1400 is configured to prompt an end-user to place a respective item in a bin and/or inspect the respective product 224 (e.g., prompt “GET A NEW SIZE OR COLOR”) and provide, using an input mechanism (e.g., button 1302) (e.g., receive in electronic form), a request that includes a requirement for an inspection of the respective product (e.g., first product 224-1) in one or more products of a bin 308. In some embodiments, the user interface 1400 includes the one or more input mechanisms (e.g., button 1302) that allow the user to modify the bin 308 using a third button 1406, communicate a further first request (e.g., reiterate block 404 of FIG. 4 for a third product 224-3) using a first button 1302, communicate a third request to purchase the first product 224-1 using a second button (e.g., button 1404, block 412 of FIG. 4), or a combination thereof. However, the present disclosure is not limited thereto. For instance, in some embodiments, a respective input mechanism in the one or more input mechanisms of the user interface is configured to communicate a request for placement in a virtual queue 206.

Referring briefly to FIGS. 15 through 18, in some embodiments, the systems and methods of the present disclosure provide a user interface (e.g., user interface 1500 of FIG. 15, user interface 1600 of FIG. 16, user interface 1700 of FIG. 17, user interface 1800 of FIG. 18, etc.) of a client application 306 that is displayed on a display 376 of a client device 300. In some embodiments, the user interface 1500 is configured to present authorization of a request to purchase each product in one or more products of a bin 308 (e.g., block 412 of FIG. 4). For instance, in some embodiments, the authorization of the request to purchase the one or more products 224 of the bin 308 is received at the client device 300 in the form of a digital tag associated with the bin 308, such as a universal product code (UPC), a quick response code (QR code), a near field communication tag (NFC tag), or a combination thereof. In some embodiments, the digital tag is presented through the user interface of the client device 300 (e.g., digital tag 1602 of FIG. 8, digital tag 1602 of FIG. 15, digital tag 1602-1 and/or digital tag 1602-2 of FIG. 16, digital tag 1602-1 and/or digital tag 1602-2 of FIG. 19, etc.). Accordingly, in some such embodiments, after receiving the authorization of the request to purchase each product, the end-user of the client device 300 is allowed to purchase the one or more products of the bin 308 (e.g., by seeing a sales associate, a kiosk POS client device, a smart phone client device, using user interface 1600 of FIG. 16, using user interface 18 of FIG. 18, etc.). However, the present disclosure is not limited thereto. For instance, in some embodiments, after receiving the authorization of the request to purchase each product the end-user has purchased the one or more products of the bin 308 (e.g., user interface 1900 of FIG. 19). In some embodiments, the digital tag 1602 is generated at the client device 300 or the server 200.

Referring briefly to FIG. 19, in some embodiments, in some embodiments, the systems and methods of the present disclosure provide a user interface 1900 of a client application 306 that is displayed on a display 376 of a client device 300. In some embodiments, the user interface 1900 is configured to present a receipt in accordance with an authorization of a request to purchase each product 224 in one or more products 224 of a bin 308 associated with a user of the client device 300 (e.g., block 412 of FIG. 4). In some embodiments, the user interface 1900 is configured to present a listing of each product in the one or more products 224 of the bin 308. In some embodiments, the listing further includes a description of a corresponding plurality of catalog information that is associated with a respective product in the one or more products 224 of the bin 308 (e.g., first product 224-1 includes catalog information of product name, corresponding product stock unit identifier (e.g., “#7197620220123”), color, size, or combination thereof of FIG. 19). However, the present disclosure is not limited thereto.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that includes a computer program mechanism embedded in a non-transitory computer-readable storage medium. For instance, the computer program product could contain instructions for operating the user interfaces described with respect to FIGS. 2A, 2B, and 3, 5, 6, 7, 8, 9, 10, 11, 12, 13, 14, 15, 16, 17, 18, and 19. These program modules can be stored on a CD-ROM, DVD, magnetic disk storage product, USB key, or any other non-transitory computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed is:

1. A computer implemented method comprising:
at a device having a display, an objective lens, a two-dimensional pixelated detector in communication with the objective lens, one or more processors, and memory storing one or more programs for execution by the one or more processors, the one or more programs comprising instructions for:
A) receiving, in electronic form, a selection of a first product in a plurality of products, wherein the selection of the first product is based, at least in part, on an evaluation of an image captured by the two-dimensional pixelated detector, thereby placing the first product in a bin of one or more products associated with a corresponding client identifier in a plurality of client identifiers;
B) receiving, in electronic form, a first request to purchase each product in the one or more products of the bin, wherein the first request comprises a requirement for an inspection, by a subject, of the first product in the one or more products;
C) communicating, to a server, in response to the receiving B), a second request for placement in a virtual queue in a memory of the server, wherein the second request comprises (i) a first corresponding location identifier associated with a physical address of the one or more products, (ii) a corresponding stock unit identifier for each product in the one or more products, and (iii) a transaction identifier of the request to purchase each product in the one or more products, thereby associating the corresponding client identifier with a respective indexed position in record of a plurality of indexed positions of the virtual queue;
D) facilitating, in accordance with a determination that the respective indexed position satisfies each threshold condition in a plurality of threshold conditions, the inspection of the first product; and
E) receiving, in response to the facilitating D), an authorization of the first request to purchase each product in the one or more products.

2. The method of claim 1, wherein the selection of the first product A) is provided by a user through an input mechanism of the device.

3. The method of claim 1, wherein the receiving A) further comprises displaying, on the display, in response to the selection of the first product, a corresponding plurality of catalog information associated with the first product.

4. The method of claim 1, wherein the receiving A) further comprises displaying, on the display, in response to the selection of the first product, a second product associated with the first product.

5. The method of claim 4, wherein the association of the second product with the first product is determined by an administrator associated with the server.

6. The method of claim 4, wherein the association of the second product with the first product is determined by one or more computational models based, at least in part, on a respective user preference for the second product.

7. The method of claim 6, wherein the respective user preference for the second product comprises a garment type, a monetary value, an expected profit, or a combination thereof.

8. The method of claim 1, wherein the user of the device is unassociated with the device.

9. The method of claim 1, wherein the transaction identifier of the communicating C) comprises a plurality of financial information associated with the user of the device.

10. The method of claim 1, wherein the authorization of the first request further comprises initiating a purchase request, receiving a payment, authorizing the payment, charging a payment amount, charging a credit account, completing a sale transaction, a capacity of a physical address, a spatial dimension associated with a set of products in the one or more products of the bin, or a combination thereof.

11. The method of claim 10, wherein the user of the device is provided with a confirmation of the authorization prior to the purchase of each product in the one or more products.

12. The method of claim 1, wherein the authorization of the first request is associated with the corresponding location identifier associated with the physical address of the one or more products.

13. The method of claim 1, wherein the record of the plurality of indexed positions further comprises, for each corresponding client device in the at least one corresponding client devices, a corresponding location identifier associated with the corresponding client device.

14. The method of claim 1, wherein the plurality of threshold conditions comprises a verification of an identity of the user, a frequency of requests for the user, a time of day, or a combination thereof.

15. The method of claim 1, wherein the image depicts a portion of an article of clothing.

16. The method of claim 1, wherein the facilitating D) is performed by the user.

17. The method of claim 1, wherein each respective position in the plurality of indexed positions further comprises a respective subject type identifier in a plurality of subject type identifiers.

18. The method of claim 17, wherein the plurality of subject identifiers comprises an inquiry type identifier, a purchase order type identifier, a return order type identifier, or a combination thereof.

19. A computer system comprising:
a display,
an objective lens,
a two-dimensional pixelated detector in communication with the objective lens,
one or more processors, and memory storing one or more programs for execution by the one or more processors, the one or more programs comprising instructions for:
A) receiving, in electronic form, a selection of a first product in a plurality of products, wherein the selection of the first product is based, at least in part, on an evaluation of an image captured by the two-dimensional pixelated detector, thereby placing the first product in a bin of one or more products associated with a corresponding client identifier in a plurality of client identifiers;
B) receiving, in electronic form, a first request to purchase each product in the one or more products of the bin, wherein the first request comprises a requirement for an inspection, by a subject, of the first product in the one or more products;
C) communicating, to a server, in response to the receiving B), a second request for placement in a virtual queue in a memory of the server, wherein the second request comprises (i) a first corresponding location identifier associated with a physical address of the one or more products, (ii) a corresponding stock unit identifier for each product in the one or more products, and (iii) a transaction identifier of the request to purchase each product in the one or more products, thereby associating the corresponding client identifier with a respective indexed position in record of a plurality of indexed positions of the virtual queue;
D) facilitating, in accordance with a determination that the respective indexed position satisfies each threshold condition in a plurality of threshold conditions, the inspection of the first product; and
E) receiving, in response to the facilitating D), an authorization of the first request to purchase each product in the one or more products.

20. A non-transitory computer-readable storage medium having stored thereon program code instructions that, when executed by a processor, cause the processor to perform a method comprising:
A) receiving, in electronic form, a selection of a first product in a plurality of products, wherein the selection of the first product is based, at least in part, on an evaluation of an image captured by a two-dimensional pixelated detector, thereby placing the first product in a bin of one or more products associated with a corresponding client identifier in a plurality of client identifiers;
B) receiving, in electronic form, a first request to purchase each product in the one or more products of the bin, wherein the first request comprises a requirement for an inspection, by a subject, of the first product in the one or more products;
C) communicating, to a server, in response to the receiving B), a second request for placement in a virtual queue in a memory of the server, wherein the second request comprises (i) a first corresponding location identifier associated with a physical address of the one or more products, (ii) a corresponding stock unit identifier for each product in the one or more products, and (iii) a transaction identifier of the request to purchase each product in the one or more products, thereby associating the corresponding client identifier with a respective indexed position in record of a plurality of indexed positions of the virtual queue;
D) facilitating, in accordance with a determination that the respective indexed position satisfies each threshold condition in a plurality of threshold conditions, the inspection of the first product; and
E) receiving, in response to the facilitating D), an authorization of the first request to purchase each product in the one or more products.
